(19) United States
(12) Patent Application Publication
(10) Pub. No.: US 2010/0235070 A1
(43) Pub. Date: Sep. 16, 2010

(54) VEHICLE AND CONTROL METHOD THEREFOR

(75) Inventor: Takashi Amano, Susono-shi (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/724,733

(22) Filed: Mar. 16, 2010

(30) Foreign Application Priority Data
Mar. 16, 2009 (JP) JP2009-063350

(51) Int. Cl. F02D 41/30; F02B 47/08; B60K 6/42

(52) U.S. Cl. 701/103; 123/568.21; 180/65.22; 180/65.21

(57) ABSTRACT

A vehicle includes: an internal combustion engine; an exhaust gas recirculation device; and a controller that controls the internal combustion engine and the exhaust gas recirculation device. When acceleration of the vehicle is greater than or equal to zero and is less than or equal to a predetermined acceleration, an ignition performed with a predetermined energy and a predetermined number of times of performance that enable the internal combustion engine to efficiently operate for one event of explosion and combustion of the internal combustion engine. When the acceleration of the vehicle is greater than the predetermined acceleration, the ignition performed with an energy that is greater than the predetermined energy and/or a number of times of performance that is greater than the predetermined number of times of performance for one event of explosion and combustion of the internal combustion engine.

### INCORPORATION BY REFERENCE

The disclosure of Japanese Patent Application No. 2009-63350 filed on Mar. 16, 2009 including the specification, drawings and abstract is incorporated herein by reference in its entirety.

### BACKGROUND OF THE INVENTION

1. Field of the Invention

The invention relates to a vehicle and a control method for the vehicle.

2. Description of the Related Art

A vehicle that is equipped with an engine and an electric motor as drive sources and that circulates burnt gas from the exhaust passageway of the engine into the intake passageway thereof has been proposed (e.g., see Japanese Patent Application Publication No. 2005-54725 (JP-A-2005-54725)). In this vehicle, when the electric motor can be used, for example, when the state of charge of a battery that supplies electric power to the electric motor is sufficiently high, etc., the fuel economy of the engine can be improved by operating the engine while circulating burnt gas from the exhaust passageway into the intake passageway, and the reduction in the output torque of the engine that is caused by the circulation of burnt gas can be restrained by outputting from the electric motor an assist torque that is determined beforehand as a torque for supplementing the reduced output torque of the engine in association with the crank angle of the engine.

However, in the foregoing vehicle, when the engine is operated while burnt gas is circulated into the intake passageway, the state of combustion in the engine is not altogether good, and unexpected torque fluctuations sometimes may occur. Such unexpected torque fluctuations cannot be restrained even by outputting a predetermined assist torque from the electric motor, so that discomfort may sometimes be caused to occupants due to vibration, noises, etc. resulting from the torque fluctuations.

### SUMMARY OF THE INVENTION

The vehicle and the control method for the vehicle of the invention propose achieving both improvement of energy efficiency and restraint of discomfort caused to occupants of the vehicle.

A first aspect of the invention relates to a vehicle that includes: an internal combustion engine capable of outputting motive power to a driving shaft that is linked to a driving wheel; an exhaust gas recirculation device that performs an exhaust gas recirculation in which exhaust gas from the internal combustion engine is recirculated into an intake system of the internal combustion engine; and a control device that controls the internal combustion engine and the exhaust gas recirculation device. When acceleration of the vehicle is greater than or equal to zero and is less than or equal to a predetermined acceleration, the control device controls the internal combustion engine and the exhaust gas recirculation device so that the exhaust gas recirculation by the exhaust gas recirculation device is performed, and so that the vehicle travels while operating the internal combustion engine with a good-fuel-economy fuel injection that is a fuel injection performed with such an injection amount of fuel injected into the internal combustion engine that a ratio of a sum of an exhaust gas recirculation amount that is an amount of the exhaust gas recirculated into the intake system by the exhaust gas recirculation device and an intake air amount of the internal combustion engine to the injection amount of fuel becomes equal to a good-fuel-economy ratio that achieves good fuel economy of the internal combustion engine, and with ignition performed with a predetermined energy and a predetermined number of times of performance that enable the internal combustion engine to efficiently operate for one event of explosion and combustion of the internal combustion engine. When the acceleration of the vehicle is greater than the predetermined acceleration, the control device controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and/or a number of times of performance that is greater than the predetermined number of times of performance for one event of explosion and combustion of the internal combustion engine.

In the foregoing aspect, when the acceleration of the vehicle is in a predetermined range that includes the value 0, the vehicle controls the internal combustion engine and the exhaust gas recirculation device so that the exhaust gas recirculation by the exhaust gas recirculation device is performed, and so that the vehicle travels while operating the internal combustion engine with a good-fuel-economy fuel injection that is a fuel injection performed with such an injection amount of fuel injected into the internal combustion engine that a ratio of a sum of an exhaust gas recirculation amount that is an amount of the exhaust gas recirculated into the intake system by the exhaust gas recirculation device and an intake air amount of the internal combustion engine to the injection amount of fuel becomes equal to a good-fuel-economy ratio that achieves good fuel economy of the internal combustion engine, and with ignition performed with a predetermined energy and a predetermined number of times of performance that enable the internal combustion engine to efficiently operate for one event of explosion and combustion of the internal combustion engine. Therefore, when the acceleration of the vehicle is within the predetermined range that includes the value 0, the energy efficiency of the vehicle can be improved. Then, when the acceleration of the vehicle is outside the predetermined range, the vehicle controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and/or a number of times of performance that is greater than the predetermined number of times of performance for one event of explosion and combustion of the internal combustion engine. If the exhaust gas recirculation by the exhaust gas recirculation device is performed and the internal combustion engine is operated with the good-fuel-economy fuel injection when the acceleration of the vehicle is outside the predetermined range, the combustion state of the internal combustion engine is considered more likely to fluctuate than when the acceleration of the vehicle is within the predetermined range. However, by operating the internal combustion engine with the ignition performed with an energy that is greater than the predetermined energy and a number of times of performance that is greater than the predetermined number of times of performance for one event of explosion and combustion of the internal combustion engine, the combustion state of the internal combustion engine can be made better, and the discomfort caused to an occupant by vibration, noise, or the like due to fluctuations of the combustion state of the internal combustion can be restrained. As a result, both the restraint of discomfort caused to occupants and improvement of the energy efficiency of the vehicle can be achieved.

A second aspect of the invention relates to a vehicle that includes: an internal combustion engine capable of outputting motive power to a driving shaft that is linked to a driving wheel; a gas recirculation device that performs an exhaust gas recirculation in which exhaust gas from the internal combustion engine is recirculated into an intake system of the internal combustion engine; and a control device that controls the internal combustion engine and the exhaust gas recirculation device. When vehicle speed is greater than or equal to a predetermined vehicle speed, the vehicle controls the internal combustion engine and the exhaust gas recirculation device so that the exhaust gas recirculation by the exhaust gas recirculation device is performed, and so that the vehicle travels while operating the internal combustion engine with a good-fuel-economy fuel injection that is a fuel injection performed with such an injection amount of fuel injected into the internal combustion engine that a ratio of a sum of an exhaust gas recirculation amount that is an amount of the exhaust gas recirculated into the intake system by the exhaust gas recirculation device and an intake air amount of the internal combustion engine to the injection amount of fuel becomes equal to a good-fuel-economy ratio that achieves good fuel economy of the internal combustion engine, and with ignition performed with a predetermined energy and a predetermined number of times of performance that enable the internal combustion engine to efficiently operate for one event of explosion and combustion of the internal combustion engine. When the vehicle speed is less than the predetermined vehicle speed, the control device controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and/or a number of times of performance that is greater than the predetermined number of times of performance for one event of explosion and combustion of the internal combustion engine.

In the foregoing aspect, when vehicle speed is greater than or equal to a predetermined vehicle speed, the vehicle controls the internal combustion engine and the exhaust gas recirculation device so that the exhaust gas recirculation by the exhaust gas recirculation device is performed, and so that the vehicle travels while operating the internal combustion engine with a good-fuel-economy fuel injection that is a fuel injection performed with such an injection amount of fuel injected into the internal combustion engine that a ratio of a sum of an exhaust gas recirculation amount that is an amount of the exhaust gas recirculated into the intake system by the exhaust gas recirculation device and an intake air amount of the internal combustion engine to the injection amount of fuel becomes equal to a good-fuel-economy ratio that achieves good fuel economy of the internal combustion engine, and with ignition performed with a predetermined energy and a predetermined number of times of performance that enable the internal combustion engine to efficiently operate for one event of explosion and combustion of the internal combustion engine. Therefore, when the vehicle speed is greater than or equal to the predetermined vehicle speed, the energy efficiency of the vehicle can be improved. Then, when the vehicle speed is less than the predetermined vehicle speed, the vehicle controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and/or a number of times of performance that is greater than the predetermined number of times of performance for one event of explosion and combustion of the internal combustion engine. If the exhaust gas recirculation by the exhaust gas recirculation device is performed and the internal combustion engine is operated with the good-fuel-economy fuel injection when the vehicle speed is less than the predetermined vehicle speed, it is considered likely to cause to an occupant discomfort caused by vibration, noise or the like caused by fluctuations of the combustion state of the internal combustion engine. However, by operating the internal combustion engine with the with ignition performed with an energy that is greater than the predetermined energy and a number of times of performance that is greater than the predetermined number of times of performance for one event of explosion and combustion of the internal combustion engine, the combustion state of the internal combustion engine can be made better, and the discomfort caused to an occupant by vibration, noise, or the like due to fluctuations of the combustion state of the internal combustion can be restrained. As a result, the vehicle is able to achieve both restraint of discomfort to occupants and improvement of the energy efficiency of the vehicle.

A third aspect of the invention relates a control method for a vehicle that includes an internal combustion engine capable of outputting motive power to a driving shaft that is linked to a driving wheel, and a recirculation device that recirculates exhaust gas from the internal combustion engine into an intake system of the internal combustion engine. The control method includes: controlling, when acceleration of the vehicle is greater than or equal to zero and is less than or equal to a predetermined acceleration, the internal combustion engine and the exhaust gas recirculation device so that the exhaust gas recirculation by the exhaust gas recirculation device is performed, and so that the vehicle travels while operating the internal combustion engine with a good-fuel-economy fuel injection that is a fuel injection performed with such an injection amount of fuel injected into the internal combustion engine that a ratio of a sum of an exhaust gas recirculation amount that is an amount of the exhaust gas recirculated into the intake system by the exhaust gas recirculation device and an intake air amount of the internal combustion engine to the injection amount of fuel becomes equal to a good-fuel-economy ratio that achieves good fuel economy of the internal combustion engine, and with ignition performed with a predetermined energy and a predetermined number of times of performance that enable the internal combustion engine to efficiently operate for one event of explosion and combustion of the internal combustion engine; and controlling, when the acceleration of the vehicle is greater than the predetermined acceleration, the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and/or a number of times of performance that is greater than the predetermined number of times of performance for one event of explosion and combustion of the internal combustion engine.

In the foregoing aspect, when the acceleration of the vehicle is in a predetermined range that includes the value 0, the control method controls the internal combustion engine and the exhaust gas recirculation device so that the exhaust gas recirculation by the exhaust gas recirculation device is performed, and so that the vehicle travels while operating the internal combustion engine with a good-fuel-economy fuel injection that is a fuel injection performed with such an injection amount of fuel injected into the internal combustion engine that a ratio of a sum of an exhaust gas recirculation amount that is an amount of the exhaust gas recirculated into the intake system by the exhaust gas recirculation device and an intake air amount of the internal combustion engine to the injection amount of fuel becomes equal to a good-fuel-economy ratio that achieves good fuel economy of the internal combustion engine, and with ignition performed with a predetermined energy and a predetermined number of times of performance that enable the internal combustion engine to efficiently operate for one event of explosion and combustion of the internal combustion engine. Therefore, when the acceleration of the vehicle is within the predetermined range that includes the value 0, the energy efficiency of the vehicle can be improved. Then, when the acceleration of the vehicle is outside the predetermined range, the vehicle controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and/or a number of times of performance that is greater than the predetermined number of times of performance for one event of explosion and combustion of the internal combustion engine. If the exhaust gas recirculation by the exhaust gas recirculation device is performed and the internal combustion engine is operated with the good-fuel-economy fuel injection when the acceleration of the vehicle is outside the predetermined range, the combustion state of the internal combustion engine is considered more likely to fluctuate than when the acceleration of the vehicle is within the predetermined range. However, by operating the internal combustion engine with the ignition performed with an energy that is greater than the predetermined energy and a number of times of performance that is greater than the predetermined number of times of performance for one event of explosion and combustion of the internal combustion engine, the combustion state of the internal combustion engine can be made better, and the discomfort caused to an occupant by vibration, noise, or the like due to fluctuations of the combustion state of the internal combustion can be restrained. As a result, both the restraint of discomfort to occupants and improvement of the energy efficiency of the vehicle can be achieved.

A fourth aspect of the invention relates to a control method for a vehicle that includes an internal combustion engine capable of outputting motive power to a driving shaft that is linked to a driving wheel, and a recirculation device that recirculates exhaust gas from the internal combustion engine into an intake system of the internal combustion engine. The control method includes: controlling, when vehicle speed is greater than or equal to a predetermined vehicle speed, the internal combustion engine and the exhaust gas recirculation device so that the exhaust gas recirculation by the exhaust gas recirculation device is performed, and so that the vehicle travels while operating the internal combustion engine with a good-fuel-economy fuel injection that is a fuel injection performed with such an injection amount of fuel injected into the internal combustion engine that a ratio of a sum of an exhaust gas recirculation amount that is an amount of the exhaust gas recirculated into the intake system by the exhaust gas recirculation device and an intake air amount of the internal combustion engine to the injection amount of fuel becomes equal to a good-fuel-economy ratio that achieves good fuel economy of the internal combustion engine, and with ignition performed with a predetermined energy and a predetermined number of times of performance that enable the internal combustion engine to efficiently operate for one event of explosion and combustion of the internal combustion engine; and controlling, when the vehicle speed is less than the predetermined vehicle speed, the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and/or a number of times of performance that is greater than the predetermined number of times of performance for one event of explosion and combustion of the internal combustion engine.

In the foregoing aspect, when vehicle speed is greater than or equal to a predetermined vehicle speed, the method controls the internal combustion engine and the exhaust gas recirculation device so that the exhaust gas recirculation by the exhaust gas recirculation device is performed, and so that the vehicle travels while operating the internal combustion engine with a good-fuel-economy fuel injection that is a fuel injection performed with such an injection amount of fuel injected into the internal combustion engine that a ratio of a sum of an exhaust gas recirculation amount that is an amount of the exhaust gas recirculated into the intake system by the exhaust gas recirculation device and an intake air amount of the internal combustion engine to the injection amount of fuel becomes equal to a good-fuel-economy ratio that achieves good fuel economy of the internal combustion engine, and with ignition performed with a predetermined energy and a predetermined number of times of performance that enable the internal combustion engine to efficiently operate for one event of explosion and combustion of the internal combustion engine. Therefore, when the vehicle speed is greater than or equal to the predetermined vehicle speed, the energy efficiency of the vehicle can be improved. Then, when the vehicle speed is less than the predetermined vehicle speed, the method controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and/or a number of times of performance that is greater than the predetermined number of times of performance for one event of explosion and combustion of the internal combustion engine. If the exhaust gas recirculation by the exhaust gas recirculation device is performed and the internal combustion engine is operated with the good-fuel-economy fuel injection when the vehicle speed is less than the predetermined vehicle speed, it is considered likely to cause to an occupant discomfort caused by vibration, noise or the like caused by fluctuations of the combustion state of the internal combustion engine. However, by operating the internal combustion engine with the with ignition performed with an energy that is greater than the predetermined energy and a number of times of performance that is greater than the predetermined number of times of performance for one event of explosion and combustion of the internal combustion engine, the combustion state of the internal combustion engine can be made better, and the discomfort caused to an occupant by vibration, noise, or the like due to fluctuations of the combustion state of the internal combustion can be restrained. As a result, the vehicle is able to achieve both restraint of discomfort to occupants and improvement of the energy efficiency of the vehicle.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a construction diagram showing a general construction of a hybrid motor vehicle as a first embodiment of the invention;

FIG. 2 is a construction diagram showing a general construction of an engine in the first embodiment;

FIG. 3 is a flowchart showing an example of an engine control routine that is executed by an engine ECU in the first embodiment;

FIG. 4 shows an example of a relation between the fuel consumption rate and the ratio GF of the total intake air amount Vg to the fuel injection amount;

FIG. 5 is a construction diagram showing a general construction of an engine in a second embodiment of the invention;

FIG. 6 is a flowchart showing an example of an engine control routine that is executed by an engine ECU in the second embodiment;

FIG. 7 is an illustrative diagram showing an example of a relation between the air/fuel ratio and the fuel consumption rate; and

FIG. 8 is a construction diagram showing a general construction of a hybrid motor vehicle according to a modification of the embodiments of the invention.

### DETAILED DESCRIPTION OF EMBODIMENTS

Forms for carrying out the invention will be described below with reference to embodiments.

### First Embodiment

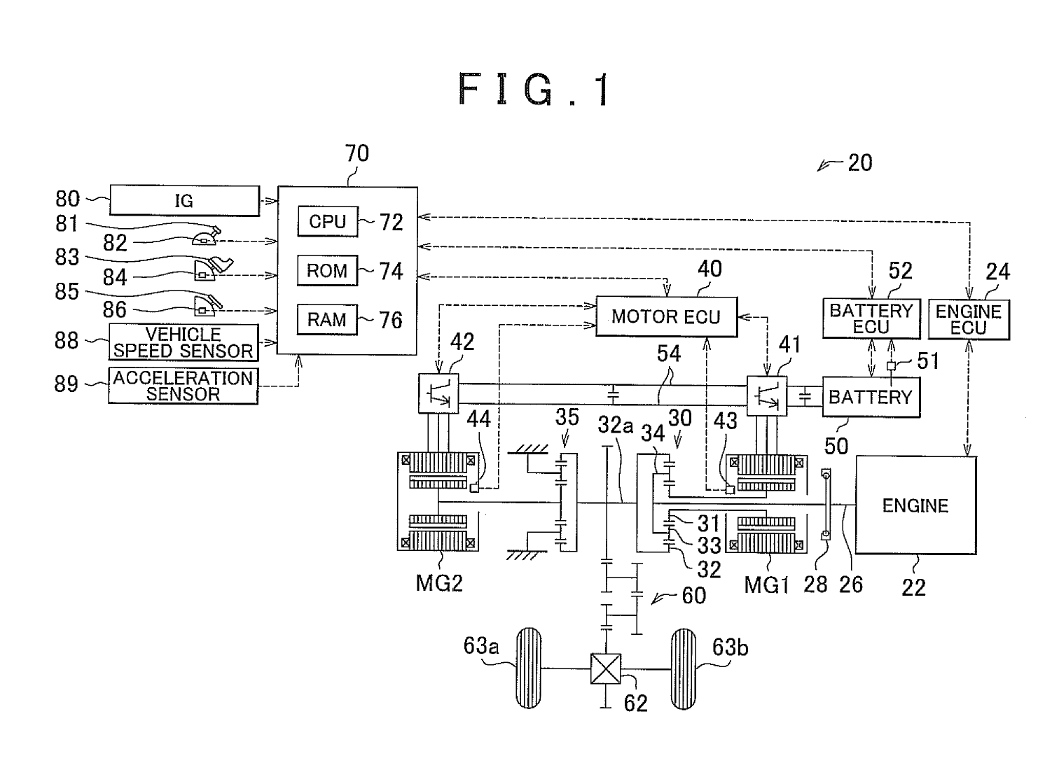

FIG. 1 is a construction diagram showing a general construction of a hybrid motor vehicle 20 as a first embodiment of the invention. The hybrid motor vehicle 20 of the first embodiment includes: an engine 22; a three-shaft power distribution-integration mechanism 30 connected via a damper 28 to a crankshaft 26 provided as an output shaft of the engine 22; an electric motor MG1 capable of generating electricity which is connected to the power distribution-integration mechanism 30; a speed reduction gear 35 attached to a ring gear shaft 32a provided as a drive shaft connected to the power distribution-integration mechanism 30; an electric motor MG2 connected to the speed reduction gear 35; and a hybrid-vehicle electronic control unit 70 that controls the entire vehicle.

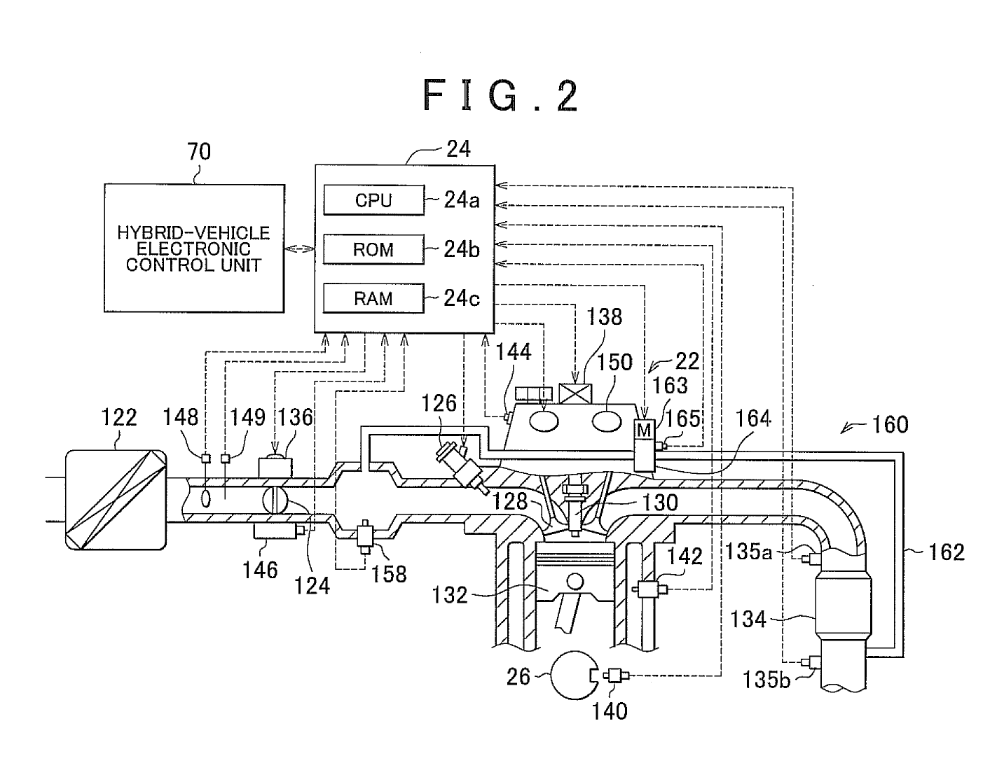

The engine 22 is constructed as, for example, an internal combustion engine that is capable of outputting power through the use of a hydrocarbon-base fuel, such as gasoline, light oil, etc. The engine 22, as shown in FIG. 2, takes in the air cleaned by an air cleaner 122, via a throttle valve 124, and mixes the intake air with gasoline by injecting gasoline from a fuel injection valve 126, and takes the mixture into a combustion chamber via an intake valve 128, and causes the explosion and combustion of the mixture due to electric sparks produced by a spark plug 130, so that energy of the explosion and combustion thrusts a piston 132, and then converts the thus-generated reciprocating motion of the piston 132 into rotating motion of a crankshaft 26.

The exhaust gas from the engine 22 is discharged into the outside air via an exhaust gas purification device 134 that has a purification catalyst (three-way catalyst) that removes harmful components, such as carbon monoxide (CO), hydrocarbon (HC) and nitrogen oxides (NOx), and is also supplied to the intake side via an EGR (Exhaust Gas Recirculation) system 160. The EGR system 160 includes an EGR pipe 162 that is connected to a site downstream of the exhaust gas purification device 134 and that is constructed so as to supply exhaust gas to the intake-side surge tank, and an EGR valve 164 that is disposed in the EGR pipe 162 and that is driven by a stepping motor 163. By adjusting the degree of opening of the EGR valve 164, the EGR system 160 adjusts the amount of exhaust gas as an unburnt gas, and then supplies the exhaust gas to the intake side. The engine 22 is constructed so as to suck a mixture of air, exhaust gas and gasoline into the combustion chamber. In the description below, supplying exhaust gas of the engine 22 to the intake side is referred to as “EGR”.

The engine 22 is controlled by an engine electronic control unit (hereinafter, termed the engine ECU) 24. The engine ECU 24 is constructed as a microprocessor that has a CPU 24a as a central component. Besides the CPU 24a, the engine ECU 24 includes a ROM 24b that stores processing programs and a RAM 24c that temporarily stores data as well as input/output ports and a communication port (which are not shown).

The engine ECU 24 accepts via input ports signals from various sensors that detect the state of the engine 22, for example: the crank position from a crank position sensor 140 that detects the rotational position of the crankshaft 26; the cooling water temperature from a water temperature sensor 142 that detects the temperature of cooling water of the engine 22; the cam position from a cam position sensor 144 that detects the rotational position of camshafts that open and close intake valves 128 and exhaust valves that perform the intake into and the discharge from the combustion chamber; the degree of throttle opening Ta from a throttle valve position sensor 146 that detects the position of the throttle valve 124; the intake air amount Qa from an air flow meter 148 attached to the intake pipe; the intake air temperature from a temperature sensor 149 attached to the intake pipe; the intake air pressure from an intake air pressure sensor 158 that detects the pressure in the intake pipe; the air/fuel ratio from an air/fuel ratio sensor 135a; an oxygen signal from an oxygen sensor 135b; the EGR valve opening degree EV from an EGR valve opening degree sensor 165 that detects the degree of opening of the EGR valve 16; etc.

The engine ECU 24 outputs via output ports various control signals for driving the engine 22, for example: a drive signal to a fuel injection valve 126, a drive signal to a throttle motor 136 that adjusts the position of the throttle valve 124, a control signal for an ignition coil 138 that is integrated with the igniter, a control signal for a variable valve timing mechanism 150 that is capable of changing the opening/closing timing of the intake valve 128, a drive signal for a stepping motor 163 that adjusts the degree of opening of the EGR valve 164; etc.

The engine ECU 24 communicates with the hybrid-vehicle electronic control unit 70, and controls the operation of the engine 22 by control signals from the hybrid-vehicle electronic control unit 70, and outputs data about the state of operation of the engine 22 according to need. Incidentally, the engine ECU 24 also computes the rotation speed of the crankshaft 26, that is, the rotation speed Ne of the engine 22, on the basis of the crank position from the crank position sensor 140, and computes a volumetric efficiency (a ratio of the volume of air that is actually taken into the engine 22 in a cycle of the engine 22 to the piston displacement per cycle of the engine 22) KL on the basis of the intake air amount Qa from the air flow meter 148 and the rotation speed Ne of the engine 22, and computes an EGR rate Re that is the rate of the EGR amount Ve that is the amount of exhaust gas supplied to the intake side to the sum of the EGR amount Ve and the intake air amount Qa of the engine 22, through the use of the intake air amount Qa from the air flow meter 148, the EGR valve opening degree EV from the EGR valve opening degree sensor 165, and the rotation speed Ne of the engine 22.

The power distribution-integration mechanism 30 is constructed as a planetary gear mechanism that includes a sun gear 31 that is an externally-toothed gear, an internally-toothed ring gear 32 disposed concentrically with the sun gear 31, a plurality of pinions 33 that mesh with the sun gear 31 and also mesh with the ring gear 32, and a carrier 34 that holds the pinions 33 so that each pinion 33 is freely rotatable about its own axis and also freely revolvable about the axis of the carrier 34. Using the sun gear 31, the ring gear 32 and the carrier 34 as rotating elements, the power distribution-integration mechanism 30 performs a differential operation. Of the power distribution-integration mechanism 30, the carrier 34 is linked to the crankshaft 26 of the engine 22, and the sun gear 31 is linked to the electric motor MG1, and the ring gear 32 is linked to the speed reduction gear 35 via the ring gear shaft 32a. When the electric motor MG1 functions as a generator, the power distribution integration mechanism 30 distributes the power of the engine 22 that is input through the carrier 34 to the sun gear 31 side and the ring gear 32 side according to the gear ratios. When the electric motor MG1 functions as an electric motor, the power distribution integration mechanism 30 integrates the power of the engine 22 that is input through the carrier 34 and the power of the electric motor MG1 input through the sun gear 31, and outputs the integrated power to the ring gear 32 side. The power output to the ring gear 32 is finally output from the ring gear shaft 32a to driving wheels 63a and 63b of the vehicle via a gear mechanism 60 and a differential gear 62.

The electric motors MG1 and MG2 are each constructed as a well-known synchronous generator-motor that is able to operate as a generator and also as an electric motor, and give electric power to and receive electric power from a battery 50 via inverters 41 and 42. Electric power lines 54 that connect the inverters 41 and 42 and the battery 50 are constructed as a positive bus and a negative bus that are shared by the inverters 41 and 42. The electric motors MG1 and MG2 are designed so that each of them is able to consume the electric power that the other electric motor MG1 or MG2 generates. Therefore, the battery 50 is charged due to electric power that is produced either one of the electric motors MG1 and MG2, and is discharged due to electric power shortage of either one of them.

Incidentally, if the electric motors MG1 and MG2 are designed so as to keep a balance between the electric power generation and consumption of the two motors. The electric motors MG1 and MG2 are each driven and controlled by a motor electronic control unit (hereinafter, termed the motor ECU) 40. Various signals needed for driving and controlling the electric motors MG1 and MG2 are input to the motor ECU 40; for example, signals from rotational position detection sensors 43 and 44 that detect the rotational positions of the rotors of the electric motors MG1 and MG2, respectively, the phase currents applied to the electric motors MG1 and MG2 which are detected by electric current sensors (not shown), etc. The motor ECU 40 outputs switching control signals to the inverters 41 and 42. The motor ECU 40 communicates with the hybrid-vehicle electronic control unit 70, and drives and controls the electric motors MG1 and MG2 by control signals from the hybrid-vehicle electronic control unit 70, and outputs to the hybrid-vehicle electronic control unit 70 data about the state of operation of the electric motors MG1 and MG2 according to need. Incidentally, the motor ECU 40 also computes the rotation speeds Nm1 and Nm2 of the electric motors MG1 and MG2 on the basis of the rotational position detection sensors 43 and 44, respectively.

The battery 50 is managed by a battery electronic control unit (hereinafter, termed the battery ECU) 52. Various signals needed for managing the battery 50 are input to the battery ECU 52, for example, an inter-terminal voltage from a voltage sensor (not shown) installed between the terminals of the battery 50, a charging/discharging current from an electric current sensor (not shown) attached to an electric power line 54 that is connected to an output terminal of the battery 50, a battery temperature Tb from a temperature sensor 51 attached to the battery 50. The battery ECU 52 outputs to the hybrid-vehicle electronic control unit 70 data about the state of the battery 50 by communication according to needs.

Besides, in order to manage the battery 50, the battery ECU 52 computes the state of charge (SOC) on the basis of the accumulated value of the charging/discharging current detected by the electric current sensor, and also computes input/output limits Win and Wout that are maximum permissible electric powers with which the battery 50 is allowed to be charged and discharged, on the basis of the computed state of charge (SOC) of the battery 50 and the battery temperature Tb. Incidentally, the input/output limits Win and Wout of the battery 50 can be set by setting basic values of the input/output limits Win and Wout on the basis of the battery temperature Tb, and setting an output-limiting correction coefficient and an input-limiting correction coefficient on the basis of the state of charge (SOC) of the battery 50, and then multiplying the basic values of the input/output limits Win and Wout by the correction coefficients.

The hybrid-vehicle electronic control unit 70 is constructed as a microprocessor that has a CPU 72 as a central component. Besides the CPU 72, the hybrid-vehicle electronic control unit 70 includes a ROM 74 that stores processing programs and a RAM 76 that temporarily stores data as well as input/output ports and a communication port (which are not shown). Various signals and the like are input to the hybrid-vehicle electronic control unit 70 via input ports, for example, an ignition signal from an ignition switch 80, a shift position SP from a shift position sensor 82 that detects the operation position of a shift lever 81, an accelerator operation amount Acc from an accelerator pedal position sensor 84 that detects the amount of depression of an accelerator pedal 83, a brake pedal position BP from a brake pedal position sensor 86 that detects the amount of depression of a brake pedal 85, a vehicle speed V from a vehicle speed sensor 88, an acceleration α from an acceleration sensor 89 that detects the acceleration of the vehicle in the longitudinal direction thereof. The hybrid-vehicle electronic control unit 70, as described above, is connected to the engine ECU 24, the motor ECU 40 and the battery ECU 52 via communication ports, and exchange various control signals and data with the engine ECU 24, the motor ECU 40 and the battery ECU 52.

The hybrid motor vehicle 20 of this embodiment constructed as described above computes a required torque that needs to be output to the ring gear shaft 32a as a drive shaft on the basis of the vehicle speed V and the accelerator operation amount Acc that corresponds to the amount of depression of the accelerator pedal 83 performed by an occupant, and operates and controls the engine 22, the electric motor MG1 and the electric motor MG2 so that a required motive power corresponding to the required torque is output to the ring gear shaft 32a.

The operation controls of the engine 22, the electric motor MG1 and the electric motor MG2 include a torque conversion operation mode in which the engine 22 is operated and controlled so as to output a motive power comparable to the required motive power, and the electric motor MG1 and the electric motor MG2 are driven and controlled so that all the motive power output from the engine 22 is torque-converted by the power distribution-integration mechanism 30, the electric motor MG1 and the electric motor MG2, and is thereby output to the ring gear shaft 32a, a charging/discharging operation mode in which the engine 22 is operated and controlled so as to output a motive power that is comparable to the sum of the required motive power and the electric power needed for charging or discharging the battery 50, and the electric motor MG1 and the electric motor MG2 are operated and controlled so that all or a portion of the motive power that is output from the engine 22 along with the charging or discharging of the battery 50 is output to the ring gear shaft 32a while being torque-converted by the power distribution-integration mechanism 30, the electric motor MG1 and the electric motor MG2, and a motor operation mode in which operation of the engine 22 is stopped and a motive power from the electric motor MG2 that is comparable to a required motive power is output to the ring gear shaft 32a. Incidentally, both the torque conversion operation mode and the charging/discharging operation mode are a mode in which the engine 22 and the electric motors MG1 and MG2 are controlled so that the required motive power is output to the ring gear shaft 32a along with operation of the engine 22, and thus do not have a difference from each other in the substantial control. Therefore, the two modes will be collectively referred to as “engine operation mode”.

During the engine operation mode, the hybrid-vehicle electronic control unit 70 sets a required torque Tr* that needs to be output to the ring gear shaft 32a as a driving shaft on the basis of the accelerator operation amount Acc from the accelerator pedal position sensor 84 and the vehicle speed V from the vehicle speed sensor 88, and calculates a traveling power Pr* that is needed for the vehicle to travel, by multiplying the set required torque Tr* by the rotation speed Nr of the ring gear shaft 32a (e.g., the rotation speed obtained by dividing the rotation speed Nm2 of the electric motor MG2 by the gear ratio of the speed reduction gear 35, or the rotation speed obtained by multiplying the vehicle speed V by a conversion factor), and sets a required power Pe* as a power that needs to be output from the engine 22, by subtracting from the calculated traveling power Pr* a charging/discharging required power Pb* of the battery 50 (whose value is positive when the battery 50 is discharged) obtained from the calculated traveling power Pr* on the basis of the state of charge (SOC) of the battery 50. Then, the hybrid-vehicle electronic control unit 70 sets the target rotation speed Ne* and the target torque Te* of the engine 22, using an operation line representing a relation between the rotation speed Ne and the torque Te of the engine 22 at which the engine 22 is able to efficiently output the required power Pe* (e.g., a fuel economy optimum operation line). Then, within the range of the input/output limits Win and Wout of the battery 50, the hybrid-vehicle electronic control unit 70 sets a torque command Tm1* as a torque that needs to be output from the electric motor MGI by a rotation speed feedback control for bringing the rotation speed Ne of the engine 22 to a target rotation speed Ne*, and sets a torque command Tm2* for the electric motor MG2 by subtracting from the required torque Tr* the torque that acts on the ring gear shaft 32a via the power distribution-integration mechanism 30 when the electric motor MG1 is driven at the torque command Tm1*. Then, the hybrid-vehicle electronic control unit 70 sends the target rotation speed Ne* and the target torque Te* to the engine ECU 24, and sends the torque commands Tm1* and Tm2* to the motor ECU 40. Then, receiving the target rotation speed Ne* and the target torque Te*, the engine ECU 24 sets a target EGR rate Re* as a target value of the EGR rate Re that is set on the basis of the target rotation speed Ne* and the target torque Te*, and sets a target degree of opening EV* as a target value of the degree of opening of the EGR valve 164 of the EGR system 160 so that the EGR rate Re becomes equal to the target EGR rate Re*. Then, the engine ECU 24 performs an intake air amount control, a fuel injection control and an ignition control of the engine 22, the opening/closing timing control of the intake valve 128, etc., so that the engine 22 is operated at the target rotation speed Ne* and the target torque Te*, and also drives the EGR valve 164 of the EGR system 160 so that the degree of opening EV of the EGR valve 164 becomes equal to the target degree of opening EV*. Besides, the motor ECU 40, receiving the torque commands Tm1* and Tm2*, performs a switching control of the switching elements of the inverters 41 and 42 so that the electric motors MG1 and MG2 are driven with the torque commands Tm1* and Tm2*.

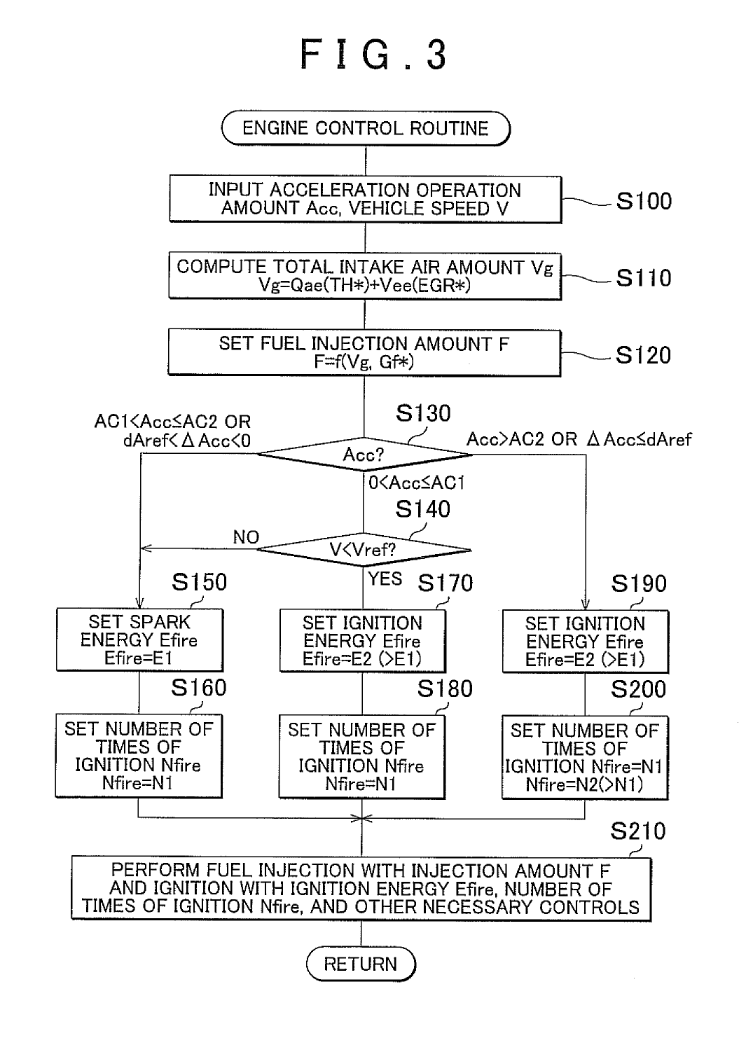

Next, operations of the hybrid motor vehicle 20 of the first embodiment and, particularly a control of the engine 22 when the vehicle traveling in the engine operation mode while performing the EGR will be described. FIG. 3 is a flowchart showing an example of an engine control routine that is executed by the engine ECU 24. This routine is repeatedly executed at every predetermined time (e.g., every several milliseconds) while the accelerator pedal 83 is depressed.

When the engine control routine of FIG. 3 begins to be executed, the engine ECU 24 (concretely, the CPU 24a) first executes a process of inputting data that is needed for the control, such as the accelerator operation amount Acc, the vehicle speed V, etc. (step S100). Concretely, the accelerator operation amount Acc and the vehicle speed V input in this routine are the data that are detected by the accelerator pedal position sensor 84 and the vehicle speed sensor 88 and that are sent from the hybrid-vehicle electronic control unit 70 by communication.

Subsequently, the engine ECU 24 calculates a total intake air amount Vg as the amount of air that the engine 22 takes in, by adding an estimated EGR amount Vee as the estimated value of the amount of air that is taken into the engine 22 via the EGR valve 164 when the EGR valve 164 is open at the target degree of opening EV* to an estimated intake air amount Qae as the estimated value of the amount of air that is taken into the engine 22 via the throttle valve 124 when the degree of opening of the throttle valve 124 is equal to the target degree of throttle opening TH* that is a target value of the degree of throttle opening set on the basis of the target torque Te* (step S110).

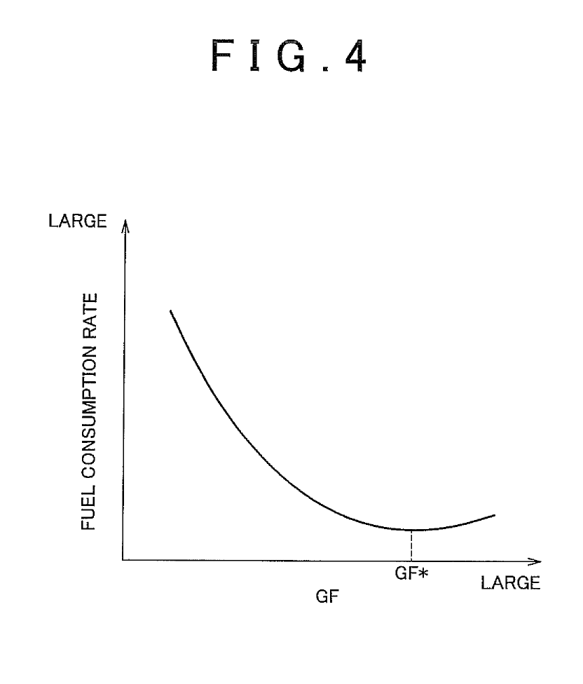

The engine ECU 24, on the basis of the calculated total intake air amount Vg, sets the fuel injection amount F so that the ratio GF of the total intake air amount Vg to the fuel injection amount F of the engine 22 becomes equal to a good-fuel-economy ratio GF* (e.g., 19.0, 20.0, 21.0, etc.) as the ratio that minimizes the fuel consumption rate that is the amount of fuel consumption of the engine 22 per unit time and per unit (step S120). The good-fuel-economy ratio GF* used herein may be determined beforehand on the basis of a relation between the fuel consumption rate and the ratio GF of the total intake air amount Vg to the fuel injection amount F. FIG. 4 shows an example of a relation between the fuel consumption rate and the ratio GF of the total intake air amount Vg to the fuel injection amount F.

Subsequently, the engine ECU 24 compares the input accelerator operation amount Acc with a threshold value AC1 (e.g., 10%, 12%, 15%, etc.) of the accelerator operation amount Acc that is slightly greater than the value 0 and that makes it possible to determine that the vehicle is traveling steadily at a substantially constant vehicle speed or with a threshold value AC2 (e.g., 25%, 30%, 35%, etc.) of the accelerator operation amount Acc that makes it possible to determine that the vehicle is gently accelerating, and compares the amount of change ΔAcc in the accelerator operation amount Acc (obtained by subtracting the presently input accelerator operation amount Acc from the previously input accelerator operation amount Acc) with the value 0 or with a threshold value dAref (e.g., −15%, −20%, −30%, etc.) of the amount of change in the accelerator operation amount that makes it possible to determine that the vehicle is sharply decelerating (step S130).

The engine ECU 24 compares the vehicle speed V with a threshold value Vref (e.g., 55 km/h, 60 km/h, 65 km/h, etc.) of the vehicle speed that makes it possible to determine that the vehicle is traveling at relatively high speed (step S140).

When the accelerator operation amount Acc is greater than the threshold value AC1 and less than or equal to the threshold value AC2, that is, when the vehicle is gently accelerating, or when the amount of change ΔAcc in the accelerator operation amount Acc is less than the value 0 and greater than the threshold value dAref, that is, when the accelerator pedal 85 has been slightly undepressed so that the vehicle is gently decelerating (AC1<Acc≦AC2 or dAref<ΔAcc<0 in step S130), the engine ECU 24 determines that the combustion state of the engine 22 is comparatively stable, and sets an energy E1 that is set beforehand as an energy for one event of explosion and combustion which is able to efficiently operate the engine 22, as the spark energy Efire (e.g., 65 mJ, 70 mJ, 75 mJ, etc.) for one event of explosion and combustion of the engine 22 (step S150), and sets the number of times N1 (e.g., once, or the like) that makes it possible to efficiently operate the engine 22 for one event of explosion and combustion of the engine 22 as the number of times of ignition Nfire (step S160), and executes the fuel injection control of driving the fuel injection valve 126 so that the fuel injection amount F of fuel is injected, and the ignition control of controlling the electrification duration of the ignition coil 138 so that the spark plug 130 fires the number of times of ignition Nfire with the spark energy Efire, and also executes necessary controls, such as the intake air amount control, the opening/closing timing control of the intake valve 128, etc. (step S210). After that, the engine ECU 24 ends the engine control routine. Due to the foregoing controls, while the vehicle is gently accelerating or gently decelerating, the fuel injection is performed in the fuel injection amount F that minimizes the fuel consumption rate, and the ignition is performed with such a spark energy Efire and such a number of times of ignition Nfire that the engine 22 can be efficiently operated. Therefore, the energy efficiency of the vehicle can be improved.

When the accelerator operation amount Acc is greater than or equal to the value 0 and less than or equal to the threshold value AC1 and the vehicle speed V is greater than or equal to the threshold value Vref, that is, when the vehicle is traveling at comparatively high speed (0≦Acc≦AC1 in step S130, and “NO” in step S140), the engine ECU 24 determines that the vibration caused by irregularities of the road surface or the like is comparatively large and therefore occurrence of fluctuations in the combustion state of the engine 22 will not cause discomfort to an occupant. Then, the engine ECU 24 sets the spark energy Efire at the energy E1, and sets the number of times of ignition Nfire at the number of times N1 (steps S150 and S160). Then, the engine ECU 24 executes the fuel injection control of driving the fuel injection valve 126 so that the fuel injection amount F of fuel is injected, and the ignition control of controlling the ignition coil 138 so that the spark plug 130 fires with the spark energy Efire and the number of times of ignition Nfire, and the like (step S210). After that, the engine ECU 24 ends the engine control routine. Due to these controls, when the vehicle is traveling steadily at comparatively high speed, the fuel injection is performed in the fuel injection amount F that minimizes the fuel consumption rate and the ignition is performed with such a spark energy Efire and such a number of times of ignition Nfire that the engine 22 can be efficiently operated. Therefore, the energy efficiency of the vehicle can be improved.

When the accelerator operation amount Acc is greater than or equal to the value 0 and less than or equal to the threshold value AC1 and the vehicle speed V is less than the threshold value Vref, that is, when the vehicle is traveling at comparatively low speed (0≦Acc≦AC1 in step S130, and “YES” in step S140), the engine ECU 24 determines that since the vibration and the traveling noise caused by irregularities of the road surface or the like are comparatively small, the noise or vibration caused by fluctuations of the combustion state of the engine 22 may possibly cause discomfort to the occupant if the engine ECU 24 performs the ignition control with the spark energy Efire and the number of times of ignition Nfire that are set in the processes of steps S150 and S160. Then, the engine ECU 24 sets an energy E2 (e.g., 95 mJ, 100 mJ, 105 mJ, etc.) that is higher than the energy E1 as the spark energy Efire (step S170), and sets the number of times N1 as the number of times of ignition Nfire (step S180). Then, the engine ECU 24 executes the fuel injection control of driving the fuel injection valve 126 so that the fuel injection amount F of fuel is injected, and the ignition control of controlling the ignition coil 138 so that the spark plug 130 fires with the spark energy Efire and the number of times of ignition Nfire, and the like (step S210). After that, the engine ECU 24 ends the engine control routine. Due to these controls, when the vehicle is traveling steadily at comparative low speed, the ignition is performed with higher energy E2 to form a stronger-energy electric spark that is used to cause explosion and combustion, so that initial flame can be rapidly formed. As a result of this, the fluctuation of the combustion state of the engine 22 is restrained, and therefore the discomfort caused to an occupant, such as noise, vibration or the like, can be restrained. Since the fuel injection is performed in the fuel injection amount F that minimizes the fuel consumption rate, the energy efficiency of the vehicle can be improved. Therefore, it is possible to achieve both improvement of energy efficiency and restraint of discomfort caused to occupants.

When the accelerator operation amount Acc is greater than the threshold value AC2, that is, when the vehicle is sharply accelerating, or when the amount of change ΔAcc in the accelerator operation amount Acc is less than or equal to the threshold value dAref, that is, when the vehicle is sharply decelerating (Acc>AC2 or Acc≦dAref in step S130), the engine ECU 24 determines that if the ignition control is performed with the spark energy Efire and the number of times of ignition Nfire set in the process of steps S150 and S160, there is possibility of the fluctuations of the combustion state of the engine 22 becoming comparatively large. Then, the engine ECU 24 sets the spark energy Efire to the energy E2 (S190), and sets the number of times of ignition Nfire to the number of times N2 (e.g., two or the like) that is greater than the number of times N1 (step S200). Then, the engine ECU 24 executes the fuel injection control of driving the fuel injection valve 126 so that the fuel injection amount F of fuel is injected, and the ignition control of controlling the ignition coil 138 so that the spark plug 130 fires with the spark energy Efire and the number of times of ignition Nfire, and the like (step S210). After that, the engine ECU 24 ends the engine control routine. As a result of this, when the vehicle is sharply accelerating or sharply decelerating, the ignition is performed with the higher energy E2, so that a stronger-energy electric spark is formed and used to cause explosion and combustion, and therefore initial flame can be rapidly formed. Besides, since the ignition is performed with an increased number of times N2, misfire can be restrained and development of flame can be prompted, so that the combustion state of the engine 22 can be made appropriate. As a result of this, noise and vibration caused by the fluctuation of the combustion state of the engine 22 are restrained, and the discomfort caused to occupants can be restrained. Since the fuel injection is performed in the fuel injection amount F that minimizes the fuel consumption rate, the energy efficiency of the vehicle can be improved. Therefore, it is possible to achieve both improvement of the energy efficiency, and restraint of discomfort caused to occupants.

According to the hybrid motor vehicle 20 of the first embodiment described above, when the accelerator operation amount Acc is greater than the threshold value AC1 and is less than or equal to the threshold value AC2, or when the amount of change ΔAcc in the accelerator operation amount Acc is less than the value 0 and greater than the threshold value dAref, or when the accelerator operation amount Acc is greater than or equal to the value 0 and less than or equal to the threshold value AC1 and the vehicle speed V is greater than or equal to the threshold value Vref, the engine ECU 24 performs the fuel injection with the fuel injection amount F that minimizes the fuel consumption rate while performing EGR, and performs the ignition with such a spark energy Efire and such a number of times of ignition Nfire that the engine 22 can be efficiently operated. Therefore, the energy efficiency of the vehicle can be improved.

Besides, when the accelerator operation amount Acc is greater than or equal to the value 0 and is less than or equal to the threshold value AC1 and the vehicle speed V is less than the threshold value Vref, the engine ECU 24 performs the fuel injection with the fuel injection amount F that minimizes the fuel consumption rate, and performs the ignition with the high energy E2 while performing the EGR. Therefore, the engine ECU 24 is able to improve the energy efficiency and is able to restrain the fluctuations of the combustion state of the engine 22 and therefore restrain the discomfort caused to an occupant, such as, such as noise, vibration or the like.

Furthermore, when the accelerator operation amount Acc is greater than the threshold value AC2 or when the amount of change ΔAcc in the accelerator operation amount Acc is less than or equal to the threshold value dAref, the engine ECU 24 performs the fuel injection with the fuel injection amount F that minimizes the fuel consumption rate, and performs the ignition with the higher energy E2 and the increased number of times N2 while performing the EGR. Therefore, it is possible to improve energy efficiency and restrain discomfort caused to an occupant. Therefore, it is possible to achieve both improvement of the energy efficiency and restraint of the discomfort caused to an occupant.

In the hybrid motor vehicle 20 of the first embodiment, when the accelerator operation amount Acc is greater than or equal to the value 0 and is less than or equal to the threshold value AC1 and the vehicle speed V is less than the threshold value Vref (0≦Acc≦AC1 in step S130 and “YES” in step S140), the engine ECU 24 sets the spark energy Efire at the higher energy E2 and sets the number of times of ignition Nfire at the number of times N1 (steps S170 and S180). However, in that case, it is also permissible to increase the number of times of ignition Nfire without increasing the spark energy Efire, or to increase both the number of times of ignition Nfire and the spark energy Efire.

Besides, when the accelerator operation amount Acc is greater than the threshold value AC2 (Acc>AC2 or ΔAcc≦dAref in step S130), the engine ECU 24 sets the spark energy Efire at the higher energy E2 and sets the number of times of ignition Nfire at the greater number of times N2 (steps S190 and S200). In that case, however, it is also permissible to either increase the spark energy Efire or increase the number of times of ignition Nfire.

In the hybrid motor vehicle 20 of the first embodiment, the engine ECU 24 checks the accelerator operation amount Acc and the vehicle speed V in the processes of steps S130 and S140, it is also possible to omit checking the vehicle speed V and check only the accelerator operation amount Acc, and to omit executing the processes of steps S140, S150, S170 and S190 and use as the spark energy Efire a predetermined energy (e.g., the energy E1) that is set beforehand.

Alternatively, it is also permissible to adopt a construction in which when the accelerator operation amount Acc is within a predetermined range from the value 0 (e.g., greater than or equal to 0% and less than 30%) or when the amount of change ΔAcc in the accelerator operation amount Acc is within a predetermined range below the value 0 (e.g., greater than −20% but less than 0%, or the like), that is, when the vehicle is steadily traveling, or gently decelerating or gently accelerating (when the acceleration of the vehicle is within a predetermined range that includes the value 0), the engine ECU 24 executes the processes of steps S150 and S160, and in which when the accelerator operation amount Acc is outside the predetermined range (e.g., greater than or equal to 30%, or the like) or when the amount of change ΔAcc in the accelerator operation amount Acc is outside the predetermined range (e.g., less than or equal to −20%, or the like), that is, when the vehicle is sharply accelerating or sharply decelerating (when the acceleration of the vehicle is outside the predetermined range), the engine ECU 24 executes the processes of steps S170 and S180 or the processes of steps S190 and S200.

Besides, it is also permissible that, in the processes of steps S130 and S140, the engine ECU 24 does not check the accelerator operation amount Acc but checks only the vehicle speed V, and that the engine ECU 24 does not execute the processes of steps S130, S160, S180 and S200, and uses a predetermined number of times (e.g., the number of times N1) that is determined beforehand, for the number of times ignition Nfire.

It is also permissible that when the vehicle speed V is greater than or equal to a predetermined vehicle speed (e.g., 60 km/h, or the like), that is, when the vehicle is traveling at comparatively high speed, the engine ECU 24 executes the processes of steps S150 and S160, and that when the vehicle speed V is less than the predetermined vehicle speed (e.g., 60 km/h, or the like), that is, when the vehicle is traveling at comparatively low speed, the engine ECU 24 executes the processes of steps S170 and S180 or the processes of steps S190 and S200.

### Second Embodiment

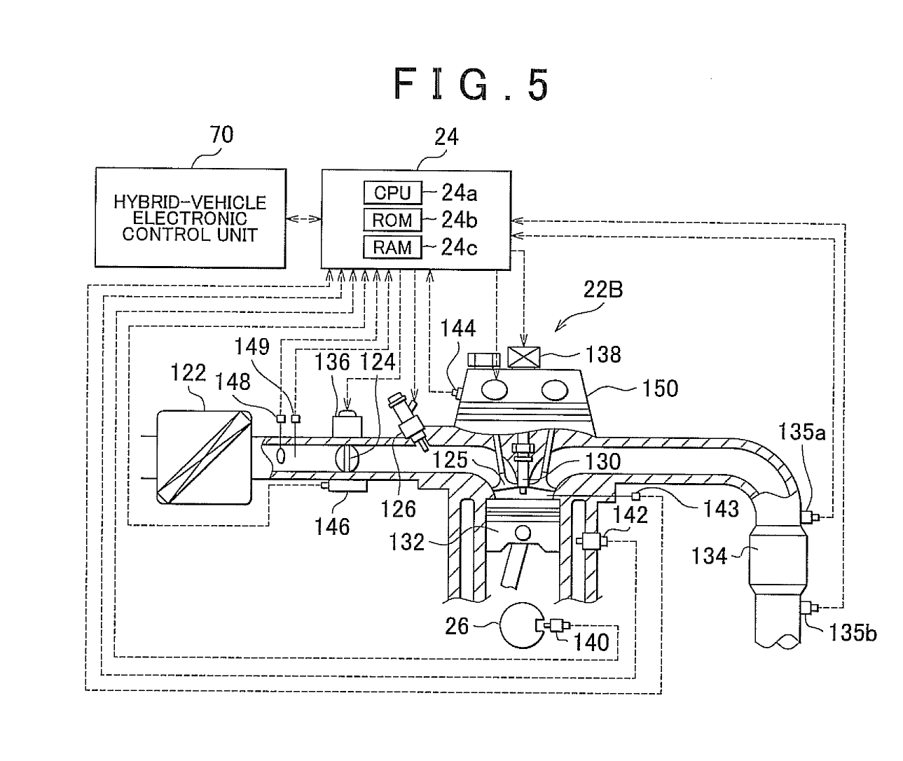

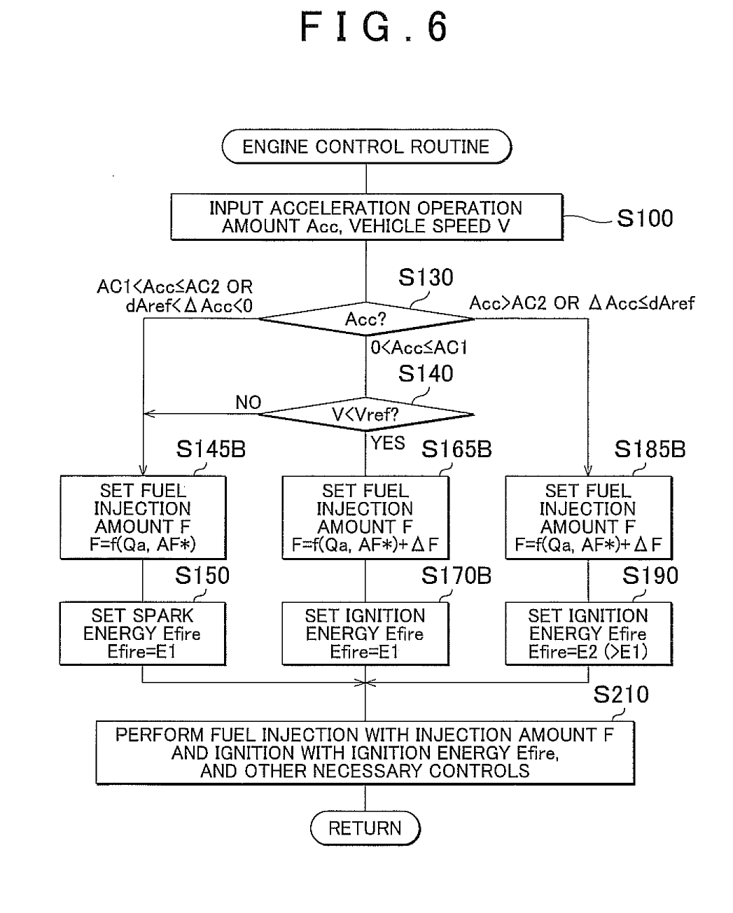

Next, a hybrid motor vehicle 20B of a second embodiment of the invention will be described. The hybrid motor vehicle 20B of the second embodiment has substantially the same construction and executes substantially the same controls as the hybrid motor vehicle 20 of the first embodiment shown in FIG. 1, except that the hybrid motor vehicle 20B is equipped with an engine 22B shown as an example in FIG. 5 instead of the engine 22B shown as an example in FIG. 2, and that the hybrid motor vehicle 20B does not perform the EGR, and that the hybrid motor vehicle 20B executes an engine control routine shown as an example in FIG. 6 instead of the engine control routine shown as an example in FIG. 3. Therefore, the construction and the controls of the hybrid motor vehicle 20B of the second embodiment that are the same as those of the hybrid motor vehicle 20 of the first embodiment are presented with the same reference characters, and descriptions thereof are omitted below.

The engine 22B has substantially the same construction of the engine 22B mounted in the hybrid motor vehicle 20 of the first embodiment, except that the engine 22B does not have either one of the EGR system 160 and the intake air pressure sensor 158, and is operated without performing the EGR.

Operations of the hybrid motor vehicle 20B of the second embodiment and, in particular, controls of the engine 22B performed when the vehicle travel in an engine operation mode will be described. FIG. 6 is a flowchart showing an example of an engine control routine that is executed by the engine ECU 24. This routine is repeatedly executed at every predetermined time (e.g., every several milliseconds) while the accelerator pedal 83 is depressed.

When the engine control routine shown in FIG. 6 begins to be executed, the engine ECU 24 (concretely, CPU 24a) first inputs data needed for the controls, such as the accelerator operation amount Acc, the vehicle speed V, etc. (step S100), and compares the input accelerator operation amount Acc with the foregoing threshold value AC1 or the foregoing threshold value AC2, and also compares the amount of change ΔAcc with the value 0 or the foregoing threshold value dAref (step S130). If the accelerator operation amount Acc is greater than or equal to the value 0 and less than or equal to the threshold value AC1 (0≦Acc≦AC1 in step S130) and the vehicle speed V is greater than or equal to a threshold value Vref, the engine ECU 24 executes the process of comparing the input vehicle speed V with the forgoing threshold value Vref (step S140).

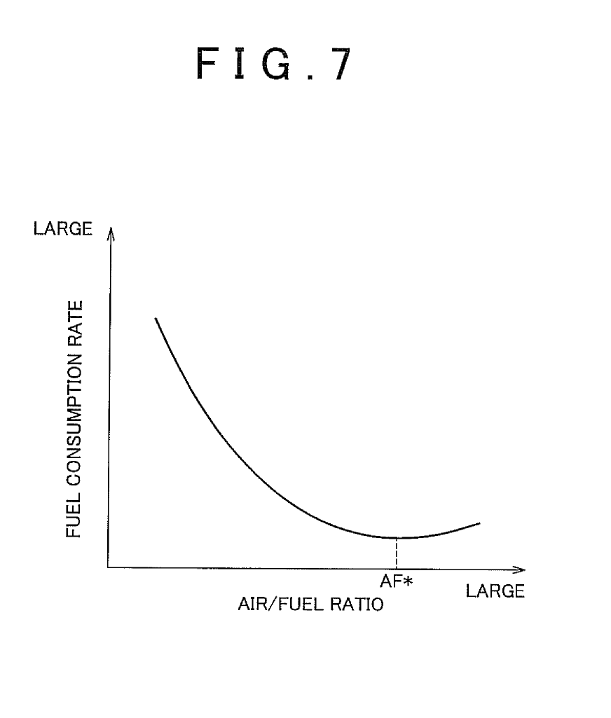

When the accelerator operation amount Acc is greater than the threshold value AC1 and less than or equal to the threshold value AC2, that is, when the vehicle is gently accelerating, or when the amount of change ΔAcc in the accelerator operation amount Acc is less than the value 0 and greater than the threshold value dAref, that is, when the accelerator pedal 85 has been undepressed and the vehicle is gently decelerating (AC1<Acc≦AC2 or dAref<ΔAcc<0 in step S130), the engine ECU 24 determines that the combustion state of the engine 22B is comparatively stable. Then, the engine ECU 24 sets the fuel injection amount F on the basis of the intake air amount Qa so that the air/fuel ratio becomes equal to a good-fuel-economy air/fuel ratio AF* (e.g., 19.0, 20.0, 21.0, etc.) that minimizes the fuel consumption rate of the engine 22B (step S145B), and sets the spark energy Efire for one event of explosion and combustion of the engine 22B at the foregoing energy E1 that is set beforehand as an energy for one event of explosion and combustion which is able to efficiently operate the engine 22B (step S150). Then, the engine ECU 24 executes the fuel injection control of driving the fuel injection valve 126 so that the fuel injection amount F of fuel is injected, and the ignition control of controlling the electrification duration of the ignition coil 138 so that the spark plug 130 fires with the spark energy Efire and a predetermined number of times (e.g., once) for one event of explosion and combustion, and also executes necessary controls, such as the intake air amount control, the opening/closing timing control of the intake valve 128, etc. (step S210). After that, the engine ECU 24 ends the engine control routine. In the process of step S145B, the good-fuel-economy air/fuel ratio AF* is determined beforehand on the basis of a relation between the fuel consumption rate and the air/fuel ratio. FIG. 7 shows an example of the relation between the fuel consumption rate and the air/fuel ratio. Due to the foregoing controls, while the vehicle is gently accelerating or gently decelerating, the fuel injection is performed in the fuel injection amount F that minimizes the fuel consumption rate, and the ignition is performed with such a spark energy Efire that the engine 22B can be efficiently operated. Therefore, the energy efficiency of the vehicle can be improved.

When the accelerator operation amount Acc is greater than or equal to the value 0 and less than or equal to the threshold value AC1 and the vehicle speed V is greater than or equal to the threshold value Vref, that is, when the vehicle is traveling at comparatively high speed (0≦Acc≦AC1 in step S130, and “NO” in step S140), the engine ECU 24 determines that the vibration caused by irregularities of the road surface or the like is comparatively large and therefore occurrence of fluctuations in the combustion state of the engine 22B will not cause discomfort to an occupant due to noise, vibration, etc. Then, the engine ECU 24 sets the fuel injection amount F on the basis of the intake air amount Qa so that the air/fuel ration becomes equal to the good-fuel-economy air/fuel ratio AF* (step S145B), and sets the spark energy Efire at the energy E1 (step S150)). Then, the engine ECU 24 executes the fuel injection control of driving the fuel injection valve 126 so that the fuel injection amount F of fuel is injected, and the ignition control of causing the spark plug 130 to fire with the spark energy Efire, and the like (step S210). After that, the engine ECU 24 ends the engine control routine. Due to these controls, when the vehicle is traveling steadily at comparatively high speed, the fuel injection is performed in the fuel injection amount F that minimizes the fuel consumption rate and the ignition is performed with such a spark energy Efire that the engine 22B can be efficiently operated. Therefore, the energy efficiency of the vehicle can be improved.

When the accelerator operation amount Acc is greater than or equal to the value 0 and less than or equal to the threshold value AC1 and the vehicle speed V is less than the threshold value Vref, that is, when the vehicle is traveling steadily at comparatively low speed (0≦Acc≦AC1 in step S130, and “YES” in step S140), the engine ECU 24 determines that since the traveling noise caused by irregularities of the road surface or the like is comparatively small, fluctuation of the combustion state of the engine 22B may possibly cause discomfort to an occupant due to noise, vibration, etc., and sets the fuel injection amount F at a value that is obtained by increasing the fuel injection amount that achieves the good-fuel-economy air/fuel ratio AF* with the intake air amount Qa by an increase value AF that is determined beforehand as an increase value that causes the engine 22B to comparatively stably operate (step S165B), and sets the spark energy Efire at the energy E1 (step S170B). Then, the engine ECU 24 executes the fuel injection control of driving the fuel injection valve 126 so that the fuel injection amount F of fuel is injected, the ignition control of causing the spark plug 130 to fire with the spark energy Efire, and the like (step S210). After that, the engine ECU 24 ends the engine control routine. The increase value ΔF used in the process of step S165B is determined beforehand through analyses or experiments as a value that brings about an air/fuel ratio that is higher than the stoichiometric air/fuel ratio (a leaner air/fuel ratio) when added to the fuel injection amount that achieves the good-fuel-economy air/fuel ratio AF* with the intake air amount Qa. Due to these controls, when the vehicle is traveling steadily at comparatively low speed, the fuel injection amount is increased, so that the fluctuation of the combustion state of the engine 22B is restrained, and therefore the discomfort caused to an occupant due to noise, vibration or the like can be restrained. Besides, since a lean state of air-fuel mixture is maintained when the mount of fuel is increased, the energy efficiency of the vehicle can be improved. Therefore, it is possible to achieve both improvement of energy efficiency and restraint of discomfort caused to occupants.

When the accelerator operation amount Acc is greater than the threshold value AC2, that is, when the vehicle is sharply accelerating, or when the amount of change ΔAcc in the accelerator operation amount Acc is less than or equal to the threshold value dAref, that is, when the vehicle is sharply decelerating (Acc>AC2 or Acc≦dAref in step S130), the engine ECU 24 determines that there is possibility of the fluctuations of the combustion state of the engine 22B becoming comparatively large. Then, the engine ECU 24 sets the fuel injection amount F at a value that is obtained by increasing the fuel injection amount that achieves the good-fuel-economy air/fuel ratio AF* with the intake air amount Qa by an increase value AF that is determined beforehand as an increase value that causes the engine 22B to comparatively stably operate (step S185B), and the spark energy Efire at the energy E2 that is higher than the energy E1 (S190). Then, the engine ECU 24 executes the fuel injection control of driving the fuel injection valve 126 so that the fuel injection amount F of fuel is injected, and the ignition control of controlling the ignition coil 138 so that the spark plug 130 fires with the spark energy Efire, and the like (step S210). After that, the engine ECU 24 ends the engine control routine. As a result of this, when the vehicle is sharply accelerating or sharply decelerating, the ignition is performed with the higher energy E2, so that a stronger-energy electric spark is formed and used to cause explosion and combustion, and therefore initial flame can be rapidly formed. Thus, the engine 22B can be further stably operated. The noise, vibration and the like caused by fluctuation of the combustion state of the engine 22B are restrained, and therefore the discomfort caused to an occupant can be restrained. Besides, since a lean state of air-fuel mixture is maintained when the mount of fuel is increased, the energy efficiency of the vehicle can be improved. Therefore, it is possible to achieve both improvement of energy efficiency and restraint of discomfort caused to occupants.

According to the hybrid motor vehicle 20B of the second embodiment described above, when the accelerator operation amount Acc is greater than the threshold value AC1 and is less than or equal to the threshold value AC2, or when the amount of change ΔAcc in the accelerator operation amount Acc is less than the value 0 and greater than the threshold value dAref, or when the accelerator operation amount Acc is greater than or equal to the value 0 and less than or equal to the threshold value AC1 and the vehicle speed V is greater than or equal to the threshold value Vref, the engine ECU 24 performs the fuel injection with the fuel injection amount F that minimizes the fuel consumption rate, and performs the ignition with such a spark energy Efire that the engine 22B can be efficiently operated. Therefore, the energy efficiency of the vehicle can be improved.

Besides, when the accelerator operation amount Acc is greater than or equal to the value 0 and is less than or equal to the threshold value AC1 and the vehicle speed V is less than the threshold value Vref, the engine ECU 24 performs the fuel injection with the fuel injection amount F that is increased from the fuel injection amount that minimizes the fuel consumption rate by such an increase amount that a lean mixture state can be maintained. Therefore, the engine ECU 24 is able to improve the energy efficiency and is able to restrain the fluctuations of the combustion state of the engine 22B and therefore restrain the discomfort caused to an occupant by noise, vibration or the like.

Furthermore, when the accelerator operation amount Acc is greater than the threshold value AC2 or when the amount of change ΔAcc in the accelerator operation amount Acc is less than or equal to the threshold value dAref, the engine ECU 24 performs the fuel injection with the fuel injection amount F that is increased from the fuel injection amount that minimizes the fuel consumption rate by such an increase amount that a lean mixture state can be maintained, and performs the ignition with the higher energy E2. Therefore, it is possible to improve energy efficiency and restrain discomfort caused to an occupant. Therefore, it is possible to achieve both improvement of the energy efficiency and restraint of the discomfort caused to an occupant.

Although in the hybrid motor vehicle 20B of the second embodiment, the engine ECU 24 changes the spark energy by performing control about the ignition in the processes of steps S150, S170B and S190, the engine ECU 24 may change the number of times of ignition instead of the ignition energy. In that case, in the processes of steps S150 and S170B, the number of times of ignition may be set at the number of times N1 (e.g., one or the like), and the number of times of ignition may be set at the number of times N2 (e.g., two or the like) in the process of step S190.

In the hybrid motor vehicle 20B of the second embodiment, when the accelerator operation amount Acc is greater than or equal to the value 0 and is less than or equal to the threshold value AC1 and the vehicle speed V is less than the threshold value Vref (0≦Acc≦AC1 in step S130 and “YES” in step S140), the engine ECU 24 increases the fuel injection amount F and keeps the spark energy Efire at the energy E1 (steps S165B and S170B). However, in that case, it is also permissible to increase the spark energy Efire without increasing the fuel injection amount f, or to increase both the spark energy Efire and the fuel injection amount f.

Besides, when the accelerator operation amount Acc is greater than the threshold value AC2 (Acc>AC2 or ΔAcc≦dAref in step S130), the engine ECU 24 increases both the fuel injection amount f and the spark energy Efire (steps S165B and S190). In that case, however, it is also permissible to increase either the spark energy Efire or the spark energy Efire.

In the hybrid motor vehicle 20B of the second embodiment, the engine ECU 24 checks the accelerator operation amount Acc and the vehicle speed V in the processes of steps S130 and S140, it is also possible to omit checking the vehicle speed V and check only the accelerator operation amount Acc, and to omit executing the processes of steps S140, S145B, S165 and S185B and use as the fuel injection amount F a predetermined injection amount that is determined beforehand (e.g., the injection amount that achieves the good-fuel-economy air/fuel ratio AF* with the intake air amount Qa).

Alternatively, it is also permissible to adopt a construction in which when the accelerator operation amount Acc is within a predetermined range that includes the value 0 (e.g., greater than or equal to 0% and less than 30%) or when the amount of change ΔAcc in the accelerator operation amount Acc is within a predetermined range below the value 0 (e.g., greater than −20% but less than 0%, or the like), that is, when the vehicle is steadily traveling, or gently decelerating or gently accelerating (when the acceleration of the vehicle is within a predetermined range that includes the value 0), the engine ECU 24 executes the processes of steps S145B and S150, and in which when the accelerator operation amount Acc is outside the predetermined range (e.g., greater than or equal to 30%, or the like) or when the amount of change ΔAcc in the accelerator operation amount Acc is outside the predetermined range (e.g., less than or equal to −20%, or the like), that is, when the vehicle is sharply accelerating or sharply decelerating (when the acceleration of the vehicle is outside the predetermined range), the engine ECU 24 executes the processes of steps S165B and S170B or the processes of steps S185B and S190.

Besides, it is also permissible that, in the processes of steps S130 and S140, the engine ECU 24 does not check the accelerator operation amount Acc but checks only the vehicle speed V, and that the engine ECU 24 does not execute the processes of steps S130, S150, S170B and S190, and uses a predetermined energy E1 that is determined beforehand as the spark energy Efire.

It is also permissible that when the vehicle speed V is lower than or equal to a predetermined vehicle speed (e.g., 60 km/h, or the like), that is, when the vehicle is traveling at comparatively low speed, the engine ECU 24 executes the processes of steps S145B and S150, and that when the vehicle speed V is greater than the predetermined vehicle speed (e.g., 60 km/h, or the like), that is, when the vehicle is traveling at comparatively high speed, the engine ECU 24 executes the processes of steps S165B and S170B or the processes of steps S185B and S190.

In the hybrid motor vehicles 20 and 20B of the first embodiment and the second embodiment, the engine ECU 24 sets the fuel injection amount F that minimizes the fuel consumption rate in the processes of steps S145B, S165B and S185B. However, it suffices that the fuel injection amount F be set so as to make the fuel consumption rate comparatively small (good). For example, the fuel injection amount F may also be set at an injection amount that is slightly greater or slightly smaller than the fuel injection amount F that minimizes the fuel consumption rate.

Although in the hybrid motor vehicles 20 and 20B of the first embodiment and the second embodiment, the engine ECU 24 checks the accelerator operation amount Acc in the process of step S130, it is also permissible to check the acceleration α detected by the acceleration sensor 89 instead of the accelerator operation amount Acc.

Although in conjunction with the hybrid motor vehicles 20 and 20B of the first embodiment and the second embodiment, the operation performed when the vehicle is traveling in the engine operation mode while the accelerator pedal 83 is depressed is described above with reference to FIGS. 3 and 4, it is also permissible to apply the foregoing construction to an operation that is performed when while the vehicle is stopped, the engine 22, 22B is to be caused to have a self-sustaining operation by an engine warmup request, or the like. In that case, as for the control of the engine 22, 22B, the hybrid motor vehicle 20, 20B performs the fuel injection control, the ignition control, the intake air amount control, etc. so as to achieve a self-sustaining operation of the engine 22 by setting the target rotation speed Ne* of the engine 22 at a predetermined rotation speed Nidle that is set beforehand for the self-sustaining operation of the engine 22 (e.g., 700 rpm, 800 rpm, 900 rpm, etc.), and setting the target rotation speed Te* at the value 0. However, it is permissible that, assuming that the vehicle speed V is less than a predetermined vehicle speed Vref, the processes of steps S170 and S180 or the processes of steps 175B and 170B are executed. This makes it possible to achieve a good combustion state of the engine 22 even when the fuel injection is performed with the fuel injection amount F that minimizes the fuel consumption rate at the time of self-sustaining operation of the engine 22, and therefore makes it possible to achieve both improvement of the fuel consumption rate and restraint of discomfort to occupants.

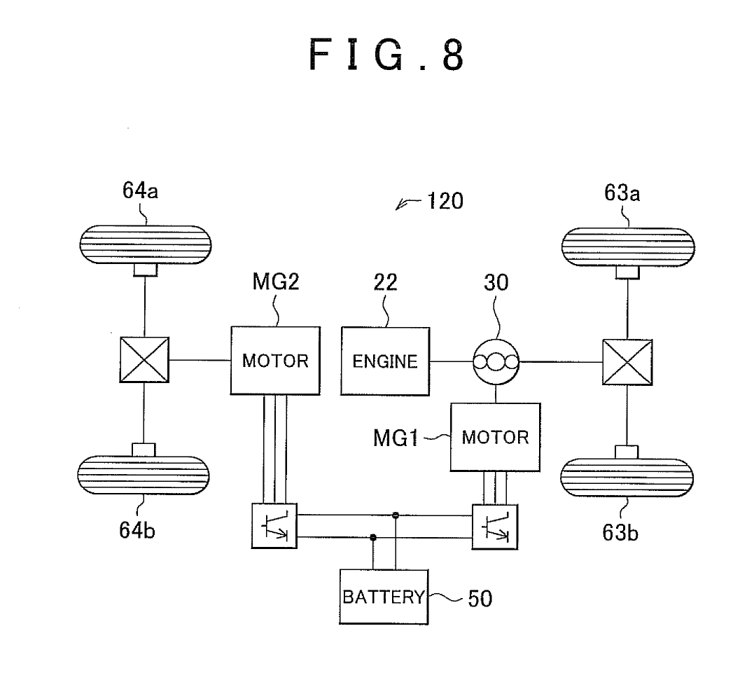

Although in the hybrid motor vehicles 20 and 20B of the first embodiment and the second embodiment, the motive power of the electric motor MG2 is changed in speed by the speed reduction gear 35, and then is output to the ring gear shaft 32a, it is also permissible to adopt a construction as in a hybrid motor vehicle 120 according to a modification of the embodiments shown in FIG. 8 in which the motive power of an electric motor MG2 is connected to an axle shaft (axle shafts connected to wheels 64a and 64b in FIG. 8) that is different from the axle shafts to which the ring gear shaft 32a is connected (axle shafts to which the driving wheels 63a, 63b are connected).

Neither the first embodiment nor the second embodiment is limited to the application to hybrid motor vehicles. The first and second embodiments may also be carried out as ordinary gasoline-engine vehicles that have only an internal combustion engine as a drive source for traveling, or may also be carried out in the form of vehicles, such as trains and the like that are other than motor vehicles. Furthermore, the invention may also be carried out as a form of method of controlling such vehicles.

A correspondence relation between major elements of the embodiments and major elements of the invention will be described.

In the first embodiment, the engine 22 can correspond to an internal combustion engine in the invention, and the EGR system 160 can correspond to an exhaust gas recirculation device in the invention. Furthermore, the engine ECU 24 that executes: the process of adjusting the EGR valve 164 of the EGR system 160 so that the degree of opening EV of the EGR valve 164 becomes equal to the target degree of opening EV*; the processes of steps S100 to S140 and steps S160, S180 and S210 in FIG. 3 in which the fuel injection valve 126 is controlled so that the fuel injection is performed with the fuel injection amount F that minimizes the fuel consumption rate when the accelerator operation amount Acc is less than or equal to the threshold value AC2, and in which the number of times of ignition Nfire is set at such a number of times N1 that the engine 22 can be efficiently operated and the ignition coil 138 is controlled so that the ignition is performed the set number of times of ignition Nfire, when the accelerator operation amount Acc is less than or equal to the threshold value AC2; and the processes of steps S100 to S140 and steps S200 and S210 in which the fuel injection valve 126 is controlled so that the fuel injection is performed with the fuel injection amount F that minimizes the fuel consumption rate when the accelerator operation amount Acc is greater than the threshold value AC2, and in which the number of times of ignition Nfire is set at the number of times N2 that is greater than the number of times N1 and the ignition coil 138 is controlled so that the ignition is performed the set number of times of ignition Nfire, when the accelerator operation amount Acc is greater than the threshold value AC2, can correspond to a control device in the invention.

In the second embodiment, the engine 22B can correspond to the internal combustion engine in the invention, and the EGR system 160 can correspond to the exhaust gas recirculation device in the invention. Furthermore, the engine ECU 24 that executes: the process of adjusting the EGR valve 164 of the EGR system 160 so that the degree of opening EV of the EGR valve 164 becomes equal to the target degree of opening EV*; the processes of steps S100 to S150 and S210 in FIG. 5 in which the fuel injection valve 126 is controlled so that the fuel injection is performed with the fuel injection amount F that minimizes the fuel consumption rate when the vehicle speed V is greater than or equal to a pre-determined vehicle speed Vref, and in which the spark energy Efire is set at such an energy E1 that the engine 22B can be efficiently operated and the ignition coil 138 is controlled so that the ignition is performed with the set spark energy Efire, when the vehicle speed V is greater than or equal to the predetermined vehicle speed Vref; and the processes of steps S100 to S140 and steps S165B and S210 in FIG. 5 in which the fuel injection is performed with the fuel injection amount F that minimizes the fuel consumption rate when the vehicle speed V is less than the predetermined vehicle speed Vref, and in which the spark energy Efire is set at the energy E2 that is greater than the energy E1 and the ignition coil 138 is controlled so that the ignition is performed with the set spark energy Efire, when the vehicle speed V is less than the predetermined vehicle speed Vref, can correspond to the control device in the invention.

In the first embodiment and the second embodiment, the electric motor MG1 can correspond to an electricity generator in the invention, and the power distribution-integration mechanism 30 can correspond to a three-shaft power input/output device in the invention, and the electric motor MG2 can correspond to an electric motor in the invention, and the battery 50 can correspond to an electricity storage device in the invention.

The internal combustion engine in the invention is not limited to the internal combustion engines that output power using a hydrocarbon-base fuel, such as gasoline, light oil, etc., but may be any internal combustion engine, for example, a hydrogen engine or the like, as long as the internal combustion engine is able to output power to a driving shaft that is connected to a driving wheel.

The exhaust gas recirculation device in the invention is not limited to the EGR system 160, but may by any device as long as the device performs an exhaust gas recirculation in which exhaust gas from the internal combustion engine is recirculated into the intake system of the internal combustion engine.

The control device in the invention is not limited to a device that executes: a process of adjusting the EGR valve 164 of the EGR system 160 so that the degree of opening EV of the EGR valve 164 becomes equal to the target degree of opening EV*; a process of controlling the fuel injection valve 126 so that the fuel injection is performed with the fuel injection amount F that minimizes the fuel consumption rate when the accelerator operation amount Acc is less than or equal to the threshold value AC2, and of setting the number of times of ignition Nfire at such a number of times N1 that the engine 22 can be efficiently operated and controlling the ignition coil 138 so that the ignition is performed with the set number of times of ignition Nfire, when the accelerator operation amount Acc is less than or equal to the threshold value AC2; and a process of controlling the fuel injection valve 126 so that the fuel injection is performed with the fuel injection amount F that minimizes the fuel consumption rate when the accelerator operation amount Acc is greater than the threshold value AC2, and of setting the number of times of ignition Nfire at the number of times N2 that is greater than the number of times N1 and controlling the ignition coil 138 so that the ignition is performed the set number of times of ignition Nfire, when the accelerator operation amount Acc is greater than the threshold value AC2. The control device in the invention may be any device as long as: when the acceleration of the vehicle is within a predetermined range that includes the value 0, the control device controls the internal combustion engine and the exhaust gas recirculation device so that the exhaust gas recirculation by the exhaust gas recirculation device is performed, and so that the vehicle travels while operating the internal combustion engine with a good-fuel-economy fuel injection that is a fuel injection with such a fuel injection amount, that is, such an amount of fuel injected into the internal combustion engine, that the ratio of the sum of an exhaust gas recirculation amount that is an amount of exhaust gas recirculated into the intake system by the exhaust gas recirculation device and the intake air amount of the internal combustion engine to the fuel injection amount becomes equal to a good-fuel-economy ratio that makes the fuel economy of the internal combustion engine good, and also with ignition performed with a predetermined energy and a predetermined number of times of ignition for one event of explosion and combustion of the internal combustion engine such that the internal combustion engine can be efficiently operated; and when the acceleration of the vehicle is outside the predetermined range, the control device controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the with ignition performed with an energy that is greater than the predetermined energy and/or a number of times of performance that is greater than the predetermined number of times for one event of explosion and combustion of the internal combustion engine.

The control device of the invention is not limited to a device that executes: a process of adjusting the EGR valve 164 of the EGR system 160 so that the degree of opening EV of the EGR valve 164 becomes equal to the target degree of opening EV*; a process of controlling the fuel injection valve 126 so that the fuel injection is performed with the fuel injection amount F that minimizes the fuel consumption rate when the vehicle speed V is greater than or equal to a pre-determined vehicle speed Vref, and of setting the spark energy Efire at such an energy E1 that the engine 22B can be efficiently operated and of controlling the ignition coil 138 so that the ignition is performed with the set spark energy Efire, when the vehicle speed V is greater than or equal to the predetermined vehicle speed Vref; and a process of performing the fuel injection with the fuel injection amount F that minimizes the fuel consumption rate when the vehicle speed V is less than the predetermined vehicle speed Vref, and in which the spark energy Efire is set at the energy E2 that is greater than the energy E1 and the ignition coil 138 is controlled so that the ignition is performed with the set spark energy Efire, when the vehicle speed V is less than the predetermined vehicle speed Vref. The control device in the invention may be any device as long as: when the vehicle speed is greater than or equal to a predetermined vehicle speed, the control device controls the internal combustion engine and the exhaust gas recirculation device so that the exhaust gas recirculation by the exhaust gas recirculation device is performed, and so that the vehicle travels while operating the internal combustion engine with a good-fuel-economy fuel injection that is a fuel injection with such a fuel injection amount, that is, such an amount of fuel injected into the internal combustion engine, that the ratio of the sum of an exhaust gas recirculation amount that is an amount of exhaust gas recirculated into the intake system by the exhaust gas recirculation device and the intake air amount of the internal combustion engine to the fuel injection amount becomes equal to a good-fuel-economy ratio that makes the fuel economy of the internal combustion engine good, and also with ignition performed with such a predetermined energy and such a predetermined number of times of ignition for one event of explosion and combustion of the internal combustion engine such that the internal combustion engine can be efficiently operated; and when the vehicle speed is less than predetermined vehicle speed, the control device controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the with ignition performed with an energy that is greater than the predetermined energy and/or a number of times of performance that is greater than the predetermined number of times for one event of explosion and combustion of the internal combustion engine.

Besides, the electricity generator in the invention is not limited to the electric motor MG2 that is constructed as a synchronous generator-motor, but may be any type of electric motor, for example, an induction electric motor or the like, as long as the electric motor is able to input and output motive power.

The three-shaft power input/output device of the invention is not limited to the foregoing power distribution-integration mechanism 30, but may be any device, for example, a device employing a double-pinion type planetary gear mechanism, a device combining a plurality of planetary gear mechanisms, a device, such as a differential gear or the like, that has a different differential operation from the planetary gear, etc., as long as the device is connected to three shafts, that is, a driving shaft, an output shaft of an internal combustion engine, and a rotation shaft of an electricity generator, and inputs or outputs motive power with respect to one of the three shafts on the basis of the motive powers input or output with respect to the other shafts.

The electric motor in the invention is not limited to the electric motor MG2 that is constructed as a synchronous generator-motor, and may be any type of electric motor, for example, an electric motor or the like, as long as the electric motor is able to input and output motive power with respect to the driving shaft.

The electricity storage device in the invention is not limited to the battery 50 as a secondary cell, and may be any device, for example, a capacitor or the like, as long as the device is able to give electric power from and receive electric power from the electric power/motive power-input/output device and the electric motor.

In the invention, when the acceleration of the vehicle is greater than or equal to the value 0 and less than or equal to a first threshold value that is greater than the value 0 and the vehicle speed is greater than or equal to a predetermined vehicle speed, or when the acceleration of the vehicle is greater than the first threshold value and is less than a second threshold value that is greater than the first threshold value, the control device may control the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with the predetermined energy and the predetermined number of times. When the acceleration of the vehicle is greater than or equal to the value 0 and is less than the first threshold value that is greater than the value 0 and the vehicle speed is less than a predetermined vehicle speed, the control device may control the internal combustion engine and the exhaust gas recirculation device so that the exhaust gas recirculation by the exhaust gas recirculation device may be performed, and so that the vehicle travels while operating the internal combustion engine with the good-fuel-economy fuel injection and with the ignition performed with energy that is greater than the predetermined energy and with the predetermined number of times. When the acceleration of the vehicle is greater than or equal to the second threshold value, the control device may control the internal combustion engine and the exhaust gas recirculation device so that the exhaust gas recirculation by the exhaust gas recirculation device is performed and so that the vehicle travels while operating the internal combustion engine with the good-fuel-economy fuel injection and with the ignition performed with an energy that is greater than the predetermined energy and a number of times of performance that is greater than the predetermined number of times for one event of explosion and combustion of the internal combustion engine.

According to the invention, even when the acceleration of the vehicle is within a predetermined range that includes the value 0, discomfort caused to an occupant by vibration or noise that is caused by fluctuation of the state of combustion of the internal combustion engine is more likely if the vehicle speed is less than a predetermined vehicle speed than if the vehicle speed is greater than or equal to the vehicle speed. However, by operating the internal combustion engine with the ignition performed with an energy that is greater than a predetermined energy and with a number of times of performance that is greater than a predetermined number of times for one event of explosion and combustion of the internal combustion engine, the discomfort caused to an occupant, such as vibration or noise that is caused by fluctuations of the state of combustion of the internal combustion engine, can be restrained.

Besides, in the invention, when the acceleration of the vehicle is greater than or equal to the value 0 and less than or equal to a first threshold value that is greater than the value 0 and the vehicle speed is greater than or equal to a predetermined vehicle speed, or when the acceleration of the vehicle is greater than the first threshold value and less than or equal to a second threshold value that is greater than the first threshold value, or when the acceleration of the vehicle less than the value 0 and is greater than or equal to a third threshold value that is less than the value 0, the control device may control the internal combustion engine and the exhaust gas recirculation device so that the exhaust gas recirculation by the exhaust gas recirculation device is performed and the vehicle travels while operating the internal combustion engine with the good-fuel-economy fuel injection and with the ignition performed with the predetermined energy and with the predetermined number of times. When the acceleration of the vehicle is greater than or equal to the value 0 and is less than or equal to the first threshold value and the vehicle speed is less than the predetermined vehicle speed, the control device may control the internal combustion engine and the exhaust gas recirculation device so that the exhaust gas recirculation by the exhaust gas recirculation device is performed and so that the vehicle travels while operating the internal combustion engine with the good-fuel-economy fuel injection and with the ignition performed with an energy that is higher than the predetermined energy and the predetermined number of times for one event of explosion and combustion of the internal combustion engine. When the acceleration of the vehicle is greater than or equal to the second threshold value, the control device may control the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and a number of times of performance that is greater than the predetermined number of times for one event of explosion and combustion of the internal combustion engine.

According to the invention, when the acceleration of the vehicle is greater than or equal to the value 0 and is less than or equal to a first threshold value that is greater than the value 0 and the vehicle speed is greater than or equal to a predetermined vehicle speed, or when the acceleration of the vehicle is greater than the first threshold value and is less than or equal to a second threshold value that is greater than the first threshold value, or when the acceleration of the vehicle is less than the value 0, and is greater than or equal to a third threshold value that is less than the value 0, the exhaust gas recirculation by the exhaust gas recirculation device is performed, and the vehicle travels while operating the internal combustion engine with the good-fuel-economy fuel injection and with the ignition performed with the predetermined energy and the predetermined number of times. Therefore, the energy efficiency of the vehicle can be improved. Besides, when the acceleration of the vehicle is greater than or equal to the value 0 and is less than or equal to the first threshold value and the vehicle speed is less than a predetermined vehicle speed, the control device controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and the predetermined number of times for one event of explosion and combustion of the internal combustion engine. Therefore, fluctuations of the combustion state of the internal combustion engine can be coped with good responsiveness so as to make the combustion state of the internal combustion engine good, and discomfort caused to an occupant by fluctuations of the combustion state of the internal combustion engine, such as vibration, noise, etc., can be restrained. Furthermore, when the acceleration of the vehicle is greater than or equal to the second threshold value, the exhaust gas recirculation by the exhaust gas recirculation device is performed and so that the vehicle travels while operating the internal combustion engine with the good-fuel-economy fuel injection and with the ignition performed with an energy that is greater than the predetermined energy and a number of times of performance that is greater than the predetermined number of times for one event of explosion and combustion of the internal combustion engine. Therefore, discomfort caused to an occupant by fluctuations of the combustion state of the internal combustion engine, such as vibration, noise, etc., can be restrained.

In the invention, the vehicle may include: an electricity generator capable of inputting and outputting motive power; a three-shaft power input/output device that is connected to three shafts that are the driving shaft, an output shaft of the internal combustion engine, and a rotation shaft of the electricity generator, and that inputs or outputs motive power with respect to one of the three shafts on the basis of the motive powers input or output with respect to the other two shafts; an electric motor capable of inputting and outputting motive power with respect to the driving shaft; and an electricity storage device capable of giving electric power to and receiving electric power from the electricity generator and the electric motor.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A vehicle comprising:
an internal combustion engine capable of outputting motive power to a driving shaft that is linked to a driving wheel;
an exhaust gas recirculation device that performs an exhaust gas recirculation in which exhaust gas from the internal combustion engine is recirculated into an intake system of the internal combustion engine; and
a control device that controls the internal combustion engine and the exhaust gas recirculation device,
wherein when acceleration of the vehicle is greater than or equal to zero and is less than or equal to a predetermined acceleration, the control device controls the internal combustion engine and the exhaust gas recirculation device so that the exhaust gas recirculation by the exhaust gas recirculation device is performed, and so that the vehicle travels while operating the internal combustion engine with a good-fuel-economy fuel injection that is a fuel injection performed with such an injection amount of fuel injected into the internal combustion engine that a ratio of a sum of an exhaust gas recirculation amount that is an amount of the exhaust gas recirculated into the intake system by the exhaust gas recirculation device and an intake air amount of the internal combustion engine to the injection amount of fuel becomes equal to a good-fuel-economy ratio that achieves good fuel economy of the internal combustion engine, and with ignition performed with a predetermined energy and a predetermined number of times of performance that enable the internal combustion engine to efficiently operate for one event of explosion and combustion of the internal combustion engine, and
wherein when the acceleration of the vehicle is greater than the predetermined acceleration, the control device controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and/or a number of times of performance that is greater than the predetermined number of times of performance for one event of explosion and combustion of the internal combustion engine.

2. The vehicle according to claim 1, wherein when the acceleration of the vehicle is greater than or equal to zero and is less than or equal to the predetermined acceleration and vehicle speed is less than a predetermined vehicle speed, the control device controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with the energy that is greater than the predetermined energy and/or the number of times of performance that is greater than the predetermined number of times of performance for one event of explosion and combustion of the internal combustion engine.

3. The vehicle according to claim 1, wherein:
when the acceleration of the vehicle is greater than or equal to zero and is less than or equal to a first threshold value that is greater than zero and vehicle speed is greater than or equal to a predetermined vehicle speed, or when the acceleration of the vehicle is greater than the first threshold value and is less than or equal to a second threshold value that is greater than the first threshold value, the control device controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with the predetermined energy and the predetermined number of times of performance;
when the acceleration of the vehicle is greater than or equal to zero and is less than the first threshold value that is greater than zero and the vehicle speed is less than the predetermined vehicle speed, the control device controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and the predetermined number of times of performance for one event of explosion and combustion of the internal combustion engine; and
when the acceleration of the vehicle is greater than or equal to the second threshold value, the control device controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and a number of times of performance that is greater than the predetermined number of times of performance for one event of explosion and combustion of the internal combustion engine.

4. The vehicle according to claim 1, wherein:
when the acceleration of the vehicle is greater than or equal to zero and is less than or equal to a first threshold value that is greater than zero and vehicle speed is greater than or equal to a predetermined vehicle speed, or when the acceleration of the vehicle is greater than the first threshold value and less than a second threshold value that is greater than the first threshold value, or when the acceleration of the vehicle is less than zero and is greater than or equal to a third threshold value that is less than zero, the control device controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with the predetermined energy and the predetermined number of times of performance;
when the acceleration of the vehicle is greater than or equal to zero and is less than or equal to the first threshold value and the vehicle speed is less than or equal to the predetermined vehicle speed, the control device controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and the predetermined number of times of performance for one event of explosion and combustion of the internal combustion engine; and
when the acceleration of the vehicle is greater than or equal to the second threshold value, the control device controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and the number of times of performance that is greater than the predetermined number of times of performance for one event of explosion and combustion of the internal combustion engine.

5. The vehicle according to claim 1, further comprising:
an electricity generator capable of inputting and outputting motive power;
a three-shaft power input/output device that is connected to three shafts that are the driving shaft, an output shaft of the internal combustion engine and a rotation shaft of the electricity generator, and that inputs or outputs motive power with respect to one shaft of the three shafts based on motive powers that are input or output with respect to two other shafts of the three shafts;
an electric motor capable of inputting and outputting motive power with respect to the driving shaft; and
an electricity storage device capable of giving and receiving electric power with the electricity generator and the electric motor.

6. The vehicle according to claim 2, further comprising:
an electricity generator capable of inputting and outputting motive power;
a three-shaft power input/output device that is connected to three shafts that are the driving shaft, an output shaft of the internal combustion engine and a rotation shaft of the electricity generator, and that inputs or outputs motive power with respect to one shaft of the three shafts based on motive powers that are input or output with respect to two other shafts of the three shafts;
an electric motor capable of inputting and outputting motive power with respect to the driving shaft; and
an electricity storage device capable of giving and receiving electric power with the electricity generator and the electric motor.

7. The vehicle according to claim 3, further comprising:
an electricity generator capable of inputting and outputting motive power;
a three-shaft power input/output device that is connected to three shafts that are the driving shaft, an output shaft of the internal combustion engine and a rotation shaft of the electricity generator, and that inputs or outputs motive power with respect to one shaft of the three shafts based on motive powers that are input or output with respect to two other shafts of the three shafts;
an electric motor capable of inputting and outputting motive power with respect to the driving shaft; and
an electricity storage device capable of giving and receiving electric power with the electricity generator and the electric motor.

8. The vehicle according to claim 4, further comprising:
an electricity generator capable of inputting and outputting motive power;
a three-shaft power input/output device that is connected to three shafts that are the driving shaft, an output shaft of the internal combustion engine and a rotation shaft of the electricity generator, and that inputs or outputs motive power with respect to one shaft of the three shafts based on motive powers that are input or output with respect to two other shafts of the three shafts;
an electric motor capable of inputting and outputting motive power with respect to the driving shaft; and
an electricity storage device capable of giving and receiving electric power with the electricity generator and the electric motor.

9. A vehicle comprising:
an internal combustion engine capable of outputting motive power to a driving shaft that is linked to a driving wheel;
an exhaust gas recirculation device that performs an exhaust gas recirculation in which exhaust gas from the internal combustion engine is recirculated into an intake system of the internal combustion engine; and
a control device that controls the internal combustion engine and the exhaust gas recirculation device,
wherein when vehicle speed is greater than or equal to a predetermined vehicle speed, the control device controls the internal combustion engine and the exhaust gas recirculation device so that the exhaust gas recirculation by the exhaust gas recirculation device is performed, and so that the vehicle travels while operating the internal combustion engine with a good-fuel-economy fuel injection that is a fuel injection performed with such an injection amount of fuel injected into the internal combustion engine that a ratio of a sum of an exhaust gas recirculation amount that is an amount of the exhaust gas recirculated into the intake system by the exhaust gas recirculation device and an intake air amount of the internal combustion engine to the injection amount of fuel becomes equal to a good-fuel-economy ratio that achieves good fuel economy of the internal combustion engine, and with ignition performed with a predetermined energy and a predetermined number of times of performance that enable the internal combustion engine to efficiently operate for one event of explosion and combustion of the internal combustion engine, and
wherein when the vehicle speed is less than the predetermined vehicle speed, the control device controls the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and/or a number of times of performance that is greater than the predetermined number of times of performance for one event of explosion and combustion of the internal combustion engine.

10. The vehicle according to claim 9, further comprising:
an electricity generator capable of inputting and outputting motive power;
a three-shaft power input/output device that is connected to three shafts that are the driving shaft, an output shaft of the internal combustion engine and a rotation shaft of the electricity generator, and that inputs or outputs motive power with respect to one shaft of the three shafts based on motive powers that are input or output with respect to two other shafts of the three shafts;
an electric motor capable of inputting and outputting motive power with respect to the driving shaft; and
an electricity storage device capable of giving and receiving electric power with the electricity generator and the electric motor.

11. A control method for a vehicle that includes an internal combustion engine capable of outputting motive power to a driving shaft that is linked to a driving wheel, and a recirculation device that performs an exhaust gas recirculation in which exhaust gas from the internal combustion engine is recirculated into an intake system of the internal combustion engine, the method comprising:
controlling, when acceleration of the vehicle is greater than or equal to zero and is less than or equal to a predetermined acceleration, the internal combustion engine and the exhaust gas recirculation device so that the exhaust gas recirculation by the exhaust gas recirculation device is performed, and so that the vehicle travels while operating the internal combustion engine with a good-fuel-economy fuel injection that is a fuel injection performed with such an injection amount of fuel injected into the internal combustion engine that a ratio of a sum of an exhaust gas recirculation amount that is an amount of the exhaust gas recirculated into the intake system by the exhaust gas recirculation device and an intake air amount of the internal combustion engine to the injection amount of fuel becomes equal to a good-fuel-economy ratio that achieves good fuel economy of the internal combustion engine, and with ignition performed with a predetermined energy and a predetermined number of times of performance that enable the internal combustion engine to efficiently operate for one event of explosion and combustion of the internal combustion engine; and
controlling, when the acceleration of the vehicle is greater than the predetermined acceleration, the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and/or a number of times of performance that is greater than the predetermined number of times of performance for one event of explosion and combustion of the internal combustion engine.

12. A control method for a vehicle that includes an internal combustion engine capable of outputting motive power to a driving shaft that is linked to a driving wheel, and a recirculation device that recirculates exhaust gas from the internal combustion engine into an intake system of the internal combustion engine, the method comprising:
controlling, when vehicle speed is greater than or equal to a predetermined vehicle speed, the internal combustion engine and the exhaust gas recirculation device so that the exhaust gas recirculation by the exhaust gas recirculation device is performed, and so that the vehicle travels while operating the internal combustion engine with a good-fuel-economy fuel injection that is a fuel injection performed with such an injection amount of fuel injected into the internal combustion engine that a ratio of a sum of an exhaust gas recirculation amount that is an amount of the exhaust gas recirculated into the intake system by the exhaust gas recirculation device and an intake air amount of the internal combustion engine to the injection amount of fuel becomes equal to a good-fuel-economy ratio that achieves good fuel economy of the internal combustion engine, and with ignition performed with a predetermined energy and a predetermined number of times of performance that enable the internal combustion engine to efficiently operate for one event of explosion and combustion of the internal combustion engine; and
controlling, when the vehicle speed is less than the predetermined vehicle speed, the internal combustion engine and the exhaust gas recirculation device so that the exhaust gas recirculation by the exhaust gas recirculation device is performed, and so that the vehicle travels while operating the internal combustion engine with the good-fuel-economy fuel injection and with the ignition performed with an energy that is greater than the predetermined energy and/or a number of times of performance that is greater than the predetermined number of times of performance for one event of explosion and combustion of the internal combustion engine.
